(19) United States
(12) Patent Application Publication
(10) Pub. No.: US 2025/0065750 A1
(43) Pub. Date: Feb. 27, 2025

(54) POWER SUPPLY APPARATUS AND POWER SUPPLY SYSTEM

(71) Applicants: DENSO CORPORATION, Kariya-city (JP); The University of Tokyo, Tokyo (JP)

(72) Inventors: Hayato SUMIYA, Kariya-city (JP); Eisuke TAKAHASHI, Kariya-city (JP); Nobuhisa YAMAGUCHI, Kariya-city (JP); Hiroshi FUJIMOTO, Tokyo (JP); Osamu SHIMIZU, Tokyo (JP)

(73) Assignees: DENSO CORPORATION, Kariya-city (JP); The University of Tokyo, Tokyo (JP)

(21) Appl. No.: 18/947,183

(22) Filed: Nov. 14, 2024

Related U.S. Application Data
(63) Continuation of application No. PCT/JP2023/014412, filed on Apr. 7, 2023.

(30) Foreign Application Priority Data
May 18, 2022 (JP) 2022-081305

(51) Int. Cl. B60L 53/62; B60L 53/12; B60L 53/30; H02J 50/00; H02J 50/12; H02J 50/50

(52) U.S. Cl. CPC B60L 53/62; B60L 53/12; H02J 50/005; H02J 50/12; H02J 50/50; B60L 53/32

(57) ABSTRACT

A power supply apparatus includes a power reception coil mounted to a moving object, a plurality of relay coils, and a power reception circuit connected with the power reception coil. The relay coils are configured to successively relay supply of electric power from a power transmission coil, which is arranged along a surface on which the moving object moves, to the power reception coil during movement of the moving object. Each of the relay coils includes a first coil and a second coil, which are configured to be magnetic-field-coupled respectively to the power transmission coil and the power reception coil, and a connection circuit that connects the first and second coils. The connection circuit includes at least one resonance capacitor involved in setting of a resonance frequency of at least one of the first and second coils. The at least one resonance capacitor has a parallel characteristic.

### CROSS-REFERENCE TO RELATED APPLICATIONS

The present application is a continuation application of International Application No. PCT/JP2023/014412 filed on Apr. 7, 2023, which is based on and claims priority from Japanese Patent Application No. 2022-081305 filed on May 18, 2022. The entire contents of these applications are incorporated by reference into the present application.

### BACKGROUND

### 1 Technical Field

The present disclosure relates to technology for supplying electric power to moving objects from road surfaces or floor surfaces.

### 2 Description of Related Art

In recent years, various techniques have been proposed for supplying electric power to moving objects, which move using wheels, in a contactless manner from road surfaces or floor surfaces.

### SUMMARY

According to the present disclosure, there is provided a power supply apparatus which includes a power reception coil, a plurality of relay coils and a power reception circuit. The power reception coil is mounted to a moving object. The plurality of relay coils are configured to successively relay supply of electric power from a power transmission coil to the power reception coil during movement of the moving object; the power transmission coil is arranged along a surface on which the moving object moves. The power reception circuit is connected with the power reception coil to receive the electric power for use in the moving object. Moreover, each of the plurality of relay coils includes a first coil configured to be magnetic-field-coupled to the power transmission coil according to movement position of the moving object, a second coil configured to be magnetic-field-coupled to the power reception coil when the first coil is magnetic-field-coupled to the power transmission coil, and a connection circuit that connects the first coil and the second coil. The connection circuit includes at least one resonance capacitor involved in setting of a resonance frequency of at least one of the first coil and the second coil. The at least one resonance capacitor has a parallel characteristic.

It should be noted that the present disclosure can also be implemented in various forms other than the above power supply apparatus, such as a power supply system and a design method thereof.

### BRIEF DESCRIPTION OF THE DRAWINGS

FIG. 1A is an explanatory diagram illustrating a power transfer system which includes a power supply apparatus according to a first embodiment.

FIG. 1B is an explanatory diagram illustrating transfer of electric power from a power transmission circuit to a power reception circuit.

FIG. 2 is an explanatory diagram illustrating the configuration of a tired wheel as viewed in a direction along a central axis of the tired wheel.

FIG. 3 is an explanatory diagram illustrating the internal configuration of the tired wheel in a cross section taken along the line III-III in FIG. 2.

FIG. 4 is an explanatory diagram schematically showing a first coil in a state of being viewed from the central axis of the tired wheel.

FIG. 5 is an explanatory diagram schematically showing a second coil in a state of being viewed from the central axis of the tired wheel.

FIG. 6 is a schematic circuit diagram illustrating the electrical configuration of the power supply apparatus.

FIG. 7 is an explanatory diagram illustrating the relationship between the phase of the tired wheel and the self-inductances of the first and second coils.

FIG. 8A is an explanatory diagram illustrating the configuration and resonance conditions of a relay coil in a PS resonance mode according to the first embodiment.

FIG. 8B is an explanatory diagram illustrating the configuration and resonance conditions of a relay coil in an SS resonance mode according to a reference example.

FIG. 9A is a graph showing the current reduction ratio of the first coil in the SS resonance mode according to the reference example and the PS resonance mode according to the first embodiment.

FIG. 9B is a graph showing the current reduction ratio of the second coil in the SS resonance mode according to the reference example and the PS resonance mode according to the first embodiment.

FIG. 10 is an explanatory diagram showing electric power supplied at different battery voltages in the SS resonance mode according to the reference example and the PS resonance mode according to the first embodiment.

FIG. 11 is an explanatory diagram giving a comparison in average electric power supplied between the SS resonance mode according to the reference example and the PS resonance mode according to the first embodiment.

FIG. 12 is an explanatory diagram illustrating an equivalent circuit of the power supply apparatus in the PS resonance mode according to the first embodiment.

FIG. 13 is an explanatory diagram showing voltage equations in the PS resonance mode according to the first embodiment.

FIG. 14 is an explanatory diagram illustrating the configurations and resonance conditions of relay coils according to second, third and fourth embodiments.

FIG. 15A is a graph showing the current reduction ratio of the first coil in each of the relay coils according to the first to fourth embodiments.

FIG. 15B is a graph showing the current reduction ratio of the second coil in each of the relay coils according to the first to fourth embodiments.

FIG. 16 is an explanatory diagram showing electric power supplied at different battery voltages with the relay coils according to the first to fourth embodiments.

FIG. 17 is an explanatory diagram giving a comparison in average electric power supplied between resonance modes according to the second, third and fourth embodiments.

FIG. 18 is an explanatory diagram illustrating an equivalent circuit of a power supply apparatus in an SP resonance mode according to the third embodiment.

FIG. 19 is an explanatory diagram showing voltage equations in the SP resonance mode according to the third embodiment.

FIG. 20 is an explanatory diagram illustrating an equivalent circuit of a power supply apparatus in an SPS resonance mode according to the fourth embodiment.

FIG. 21 is an explanatory diagram showing voltage equations in the SPS resonance mode according to the fourth embodiment.

FIG. 22 is an explanatory diagram illustrating the configurations and resonance conditions of relay coils according to fifth, sixth and seventh embodiments.

FIG. 23 is an explanatory diagram illustrating the arrangement of relay coils in a power supply apparatus according to an eighth embodiment.

FIG. 24 is an explanatory diagram illustrating a modification of the eighth embodiment.

### DESCRIPTION OF EMBODIMENTS

For example, Japanese Patent Application Publication No. JP 2021-023003 A discloses a configuration in which relay coils are provided in a wheel of a vehicle and electric power is supplied, via the relay coils, to the vehicle during traveling thereof.

The configuration disclosed in the above patent document is designed to supply electric power from a power transmission coil to a power reception coil on the vehicle side via the relay coils provided in the wheel. The configuration has an advantage of being capable of reducing intervals between the power transmission coil and the relay coils and thereby improving the electric power transfer efficiency. However, the positions of the relay coils relative to the power transmission coil and the power reception coil change during rotation of the wheel; therefore, it is desired to provide a configuration capable of further improving the system-wide electric power transfer efficiency.

The present disclosure has been accomplished in view of the above circumstances.

With the configuration of the above-described power supply apparatus according to the present disclosure, it becomes possible to reduce, for each of the plurality of relay coils, both the interval between the power transmission coil and the first coil of the relay coil and the interval between the second coil of the relay coil and the power reception coil. Consequently, it becomes possible to improve the efficiency of electric power transfer from the power transmission coil to the power reception coil. Moreover, with the parallel characteristic of the at least one resonance capacitor involved in setting of a resonance frequency of at least one of the first coil and the second coil, it becomes possible to suppress currents flowing respectively through those of the plurality of relay coils which do not directly face the power transmission coil. As a result, it becomes possible to improve the electric power supply efficiency of the power supply apparatus.

Exemplary embodiments will be described hereinafter with reference to the drawings. It should be noted that for the sake of clarity and understanding, identical components having identical functions throughout the whole description have been marked, where possible, with the same reference numerals in the drawings and that for the sake of avoiding redundancy, descriptions of identical components will not be repeated.

### A. First Embodiment

### A1. Overall Configuration of Power Transfer System

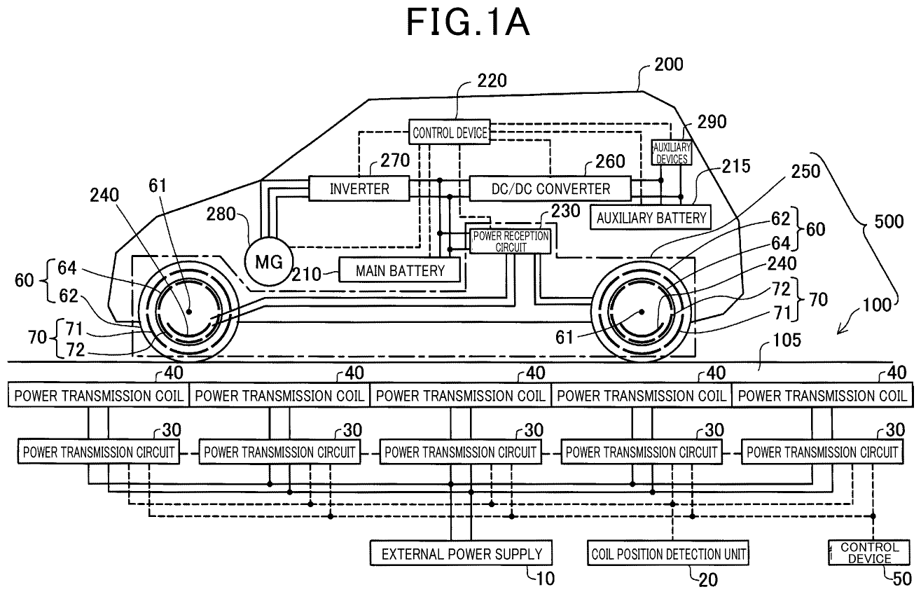

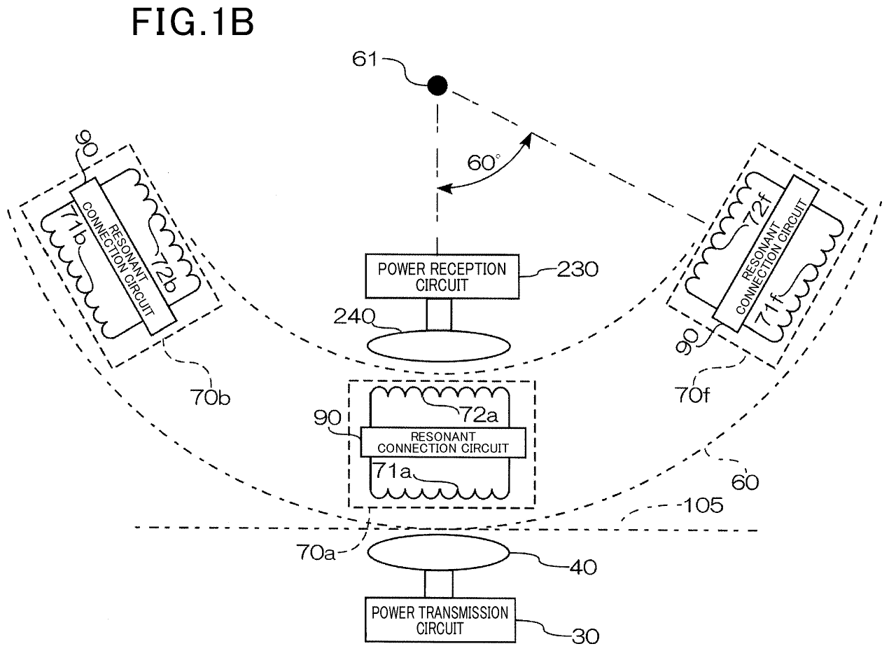

FIG. 1A illustrates the overall configuration of a power transfer system 500 which includes a power supply apparatus 250 according to the first embodiment. The power transfer system 500 is a system for supplying electric power from a road 105 to a vehicle 200. The vehicle 200 is a moving object that moves on the surface of the road 105. As shown in FIG. 1A, the power transfer system 500 includes a power transmission system 100 provided in the road 105 and the power supply apparatus 250 installed in the vehicle 200. The power transfer system 500 is configured to transfer electric power, using relay coils 70 provided in tired wheels 60 of the vehicle 200, from the power transmission system 100 to the power supply apparatus 250 when the vehicle 200 is in a stopped or traveling state. The tired wheels 60 are in contact with the road 105, but electrically not in contact with the power transmission system 100. The electric power from the power transmission system 100 is transferred, through one of the relay coils 70 provided in tired wheels 60 of the vehicle 200, to the power supply apparatus 250. The detailed mechanism of the electric power transfer will be described later.

The vehicle 200, which receives the electric power transferred in a contactless manner, may be configured as, for example, an electric vehicle that obtains mechanical power by driving a motor using electricity as an energy source. Alternatively, the vehicle 200 may be configured as a hybrid vehicle that is equipped with a mechanical power source, such as an internal combustion engine, in addition to a motor. Moreover, the vehicle 200 is not limited to a four-wheeled vehicle, but may alternatively be a three-wheeled vehicle, a two-wheeled vehicle such as a motorcycle, or a vehicle with more than four wheels such as a truck. Furthermore, the vehicle 200 may alternatively be a guided vehicle or self-propelled robot used in a factory or the like. In addition, the vehicle 200 may move, as a moving object, on an indoor floor surface as well as on the surface of the outdoor road 105.

The power transmission system 100 on the road 105 side includes: a plurality of power transmission coils 40 embedded in the road 105; a plurality of power transmission circuits 30 for applying an AC voltage and thereby supplying electric power respectively to the power transmission coils 40; an external power supply 10 (to be simply referred as the “power supply 10” hereinafter) for supplying electric power to the power transmission circuits 30; a coil position detection unit 20; and a control device 50.

In the present embodiment, the power transmission coils 40 are installed along a traveling direction of the road 105. It should be noted that the power transmission coils 40 may be arranged not only in one direction but also two-dimensionally. Each of the power transmission circuits 30 is a circuit that converts a DC voltage supplied from the power supply 10 into a high-frequency AC voltage and applies the high-frequency AC voltage to a corresponding one of the power transmission coils 40. The power transmission circuits 30 will be described in detail later. The power supply 10 is a circuit that supplies the DC voltage to the power transmission circuits 30. For example, the power supply 10 may supply electric power from a power grid to the power transmission circuits 30 via a Power Factor Correction (PFC) circuit. The PFC circuit is not shown in the drawings. It should be noted that: the DC voltage outputted from the power supply 10 may not be a perfect DC voltage; that is, the DC voltage may include fluctuation (or ripple) to a certain extent. It also should be noted that: filters are generally provided between the power transmission circuits 30 and the power transmission coils 40; however, the filters are not shown in FIG. 1A. In addition, the filters will be described later when describing electric circuits involved in the electric power transmission.

The coil position detection unit 20 detects the positions of the relay coils 70, which are mounted to the tired wheels 60 of the vehicle 200, relative to the power transmission coils 40. For example, the coil position detection unit 20 may detect the positions of the relay coils 70 based on the magnitudes of the transmitted powers or transmitted currents in the power transmission circuits 30. Alternatively, the coil position detection unit 20 may detect the positions of the relay coils 70 via wireless communication with the vehicle 200 or using a position sensor that detects the position of the vehicle 200. Otherwise, since the relay coils 70 are provided in the tired wheels 60, the positions of the relay coils 70 may be detected based on the loads received from the tired wheels 60. According to the positions of the relay coils 70 detected by the coil position detection unit 20, the control device 50 causes one or more pairs of the power transmission circuits 30 and the power transmission coils 40 located near the relay coils 70 to transmit electric power.

### A2. Configuration of Power Supply Apparatus

The vehicle 200 includes the aforementioned relay coils 70, a power reception circuit 230 and power reception coils 240, which together constitute the power supply apparatus 250. Moreover, the vehicle 200 also includes a main battery 210, an auxiliary battery 215, a control device 220, a DC/DC converter circuit 260, an inverter circuit 270, a motor-generator 280 and auxiliary devices 290. Each of the tired wheels 60 includes a tire 62 and a wheel 64. Each of the power reception coils 240 is provided inside the wheel 64 (i.e., on a central axis 61 side) of a corresponding one of the tired wheels 60. The power reception circuit 230 is connected with the power reception coils 240. To an output side of the power reception circuit 230, there are connected the main battery 210, a higher-voltage side of the DC/DC converter circuit 260 and the inverter circuit 270. Further, to a lower-voltage side of the DC/DC converter circuit 260, there are connected the auxiliary battery 215 and the auxiliary devices 290. To the inverter circuit 270, there is connected the motor-generator 280.

The power reception circuit 230 shown in FIG. 1A includes a rectifier circuit that rectifies the AC current outputted from the power reception coils 240 into DC current. In addition, the power reception circuit 230 may further include a DC/DC converter circuit for converting the DC voltage generated by the rectifier circuit into a DC voltage suitable for charging the main battery 210. The DC power outputted from the power reception circuit 230 can be used for charging the main battery 210 and for driving the motor-generator 280 via the inverter circuit 270. Moreover, the DC power outputted from the power reception circuit 230 can also be used, through a voltage step-down by the DC/DC converter circuit 260, for charging the auxiliary battery 215 and for driving the auxiliary devices 290.

The main battery 210 is a secondary battery that outputs a relatively high DC voltage for driving the motor-generator 280. The motor-generator 280 operates as a three-phase AC motor to generate a driving force for driving the vehicle 200 to travel. Otherwise, during deceleration of the vehicle 200, the motor-generator 280 operates as an electric generator to generate a three-phase AC voltage. Moreover, when the motor-generator 280 operates as a three-phase AC motor, the inverter circuit 270 converts the DC voltage outputted from the main battery 210 into a three-phase AC voltage and supplies the three-phase AC voltage to the motor-generator 280. Otherwise, when the motor-generator 280 operates as an electric generator, the inverter circuit 270 converts the three-phase AC voltage outputted from the motor-generator 280 into a DC voltage and supplies the DC voltage to the main battery 210.

The DC/DC converter circuit 260 converts the DC voltage outputted from the main battery 210 into a DC voltage suitable for driving the auxiliary devices 290 and supplies the resultant DC voltage to the auxiliary battery 215 and the auxiliary devices 290. The auxiliary battery 215 is a secondary battery that outputs a DC voltage for driving the auxiliary devices 290. The auxiliary devices 290 include peripheral devices, such as an air conditioner, an electric power steering device, a headlight, a direction indicator and a wiper of the vehicle 200, and various accessories of the vehicle 200. It should be noted that the DC/DC converter circuit 260 may not be provided in the vehicle 200 if no voltage conversion is required between the main battery 210 and the auxiliary battery 215.

The control device 220 controls each above-described component in the vehicle 200. When the vehicle 200 receives contactless power supply during traveling thereof, the control device 220 controls the power reception circuit 230 to perform processes required for receiving the supplied electric power.

### A3. Configuration of Relay Coils

Each of the relay coils 70 is provided in a corresponding one of the tired wheels 60. As shown in FIG. 1B, each of the relay coils 70 includes a first coil 71, a second coil 72, and a resonant connection circuit 90 that connects the two coils 71 and 72. In the present embodiment, in each of the tired wheels 60, there are provided six relay coils 70 at equal angular intervals around the central axis 61 (or the rotation axis) of the tired wheel 60; that is, the six relay coils 70 are spaced part by a central angle of 60° from one another. Hereinafter, the six relay coils 70 will be respectively referred to as the relay coils 70a, 70b, 70c, 70d, 70e and 70f when it is necessary to distinguish them from one another, and be simply referred to as the relay coils 70 when it is unnecessary to distinguish them from one another. In FIG. 1B, there are shown, of the six relay coils 70, only the relay coil 70a and the relay coils 70b and 70f that are adjacent to the relay coil 70a. In each of the relay coils 70, the first coil 71, the second coil 72 and the resonant connection circuit 90 are connected by wires.

The first coil 71 is provided outside the wheel 64, i.e., on the tire 62 side in the corresponding tired wheel 60. On the other hand, the second coil 72 is provided inside the wheel 64 in the corresponding tired wheel 60. Therefore, the distance from the central axis 61 of the corresponding tired wheel 60 to the first coil 71 is different from the distance from the central axis 61 to the second coil 72, more specifically longer than the distance from the central axis 61 to the second coil 72. Consequently, the first coil 71 can be located closer than the second coil 72 to the power transmission coils 40 embedded in the road 105. When the corresponding tired wheel 60 rotates and thus the first coil 71 comes to face one of the power transmission coils 40 embedded in the road 105, the first coil 71 and the power transmission coil 40 are magnetic-field-coupled (or magnetically coupled) to each other and AC current is induced in the first coil 71 by electromagnetic induction between the first coil 71 and the power transmission coil 40 to which the AC voltage is applied. Moreover, the first coil 71 and the second coil 72 are connected via the resonant connection circuit 90; therefore, the induced AC current flows from the first coil 71 to the second coil 72 through the resonant connection circuit 90. At this time, the power reception coil 240 provided in the corresponding tired wheel 60 is located at a position facing the second coil 72; thus, the second coil 72 and the power reception coil 240 are magnetic-field-coupled to each other. As a result, by electromagnetic induction between the power reception coil 240 and the second coil 72 through which the induced AC current is flowing, AC current is also induced in the power reception coil 240. In this way, the relay coil 70 relays, with the first and second coils 71 and 72, transfer of electric power from the power transmission coil 40 to the power reception coil 240. That is, as shown in FIG. 1B, electric power is transferred from the power transmission circuit 30 to the power reception circuit 230 via the power transmission coil 40, the relay coil 70 (i.e., the first and second coils 71 and 72) and the power reception coil 240.

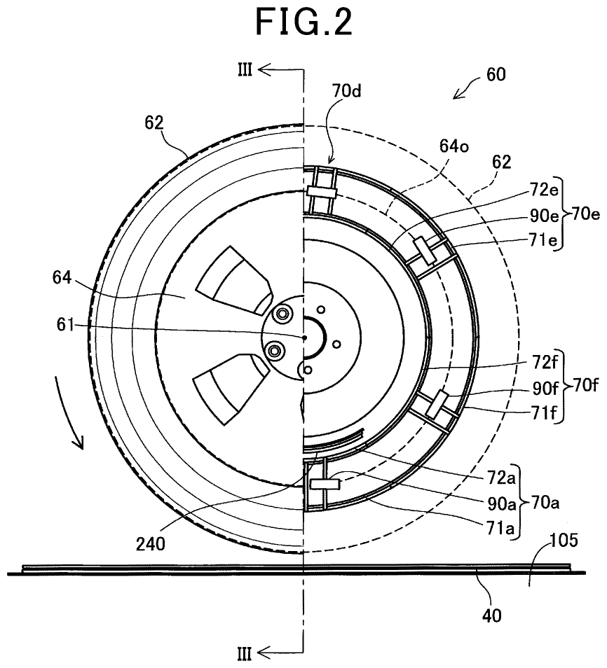

FIG. 2 is an explanatory diagram illustrating the configuration of each of the tired wheels 60 as viewed in a direction along the central axis 61 of the tired wheel 60. It should be noted that for the sake of facilitating understanding, the right half of FIG. 2 is shown as a perspective view. As shown in FIG. 2, for each of the relay coils 70, the first coil 71 is arranged outside an outer periphery 640 of the wheel 64 and inside the tire 62; and the second coil 72 is arranged inside the outer periphery 640 of the wheel 64. The power reception coil 240 is mounted, on the inner side of the outer periphery 640 of the wheel 64, to the vehicle 200. The power reception coil 240 may be attached to the vehicle 200 in a similar manner to, for example, a brake caliper of a disc brake. Consequently, the relative position between the power reception coil 240 and the tired wheel 60 remains unchanged regardless of the traveling state of the vehicle 200.

FIG. 2 shows, of the six relay coils 70 provided in the tired wheel 60, only the relay coils 70a, 70b, 70c and 70d. For each adjacent pair of the relay coils 70, the first coils 71 of the pair of the relay coils 70 are arranged so as not to overlap each other; and the second coils 72 of the pair of the relay coils 70 are also arranged so as not to overlap each other. Accordingly, the size of each of the first coils 71 in the circumferential direction of the tired wheel 60 is slightly smaller than ⅙ of the circumference of the tired wheel 60 at the radial position where the first coils 71 are arranged; and the size of each of the second coils 72 in the circumferential direction of the tired wheel 60 is slightly smaller than ⅙ of the circumference of the tired wheel 60 at the radial position where the second coils 72 are arranged. Alternatively, for each adjacent pair of the relay coils 70, the first coils 71 of the pair of the relay coils 70 may be arranged so as to overlap each other; and the second coils 72 of the pair of the relay coils 70 may also be arranged so as to overlap each other. In addition, the six relay coils 70 may be used in units of three relay coils to constitute three phases.

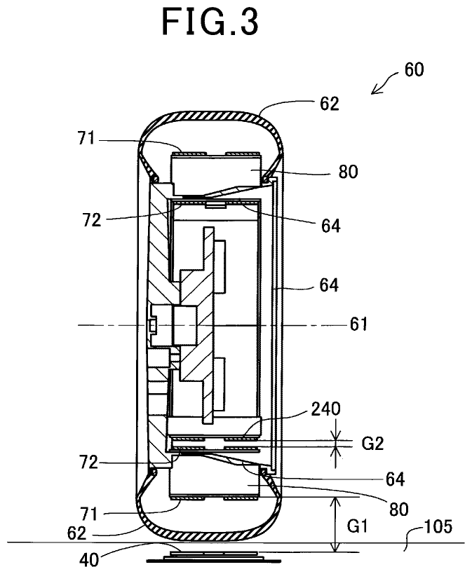

FIG. 3 is an explanatory diagram illustrating the configuration of each of the tired wheels 60 as viewed in a direction perpendicular to the central axis 61 of the tired wheel 60. It should be noted that part of FIG. 3 is shown as a perspective view. As shown in FIG. 3, in each of the relay coils 70, the first coil 71 is arranged within the tire 62 and held by a thermally-conductive plate 80; the tire 62 is located on the outer side of the wheel 64. The thermally-conductive plate 80 is formed of aluminum which has high thermal conductivity. Moreover, the thermally-conductive plate 80 is formed, on an outer circumferential surface of the wheel 64 that is formed by aluminum die-casting, separately from or integrally with the wheel 63. In the first embodiment, the surface of the thermally-conductive plate 80 is subjected to an insulation treatment; then, a parallel resonance capacitor (Ct1), which will be described later, is mounted to the thermally-conductive plate 80. It should be noted that the entire resonant connection circuit 90 may be mounted to the thermally-conductive plate 80. Since the first coil 71 and the second coil 72 are located respectively in the tire 62 and the wheel 62, electrical conductors, which connect the two coils 71 and 72, are arranged so as to penetrate the wheel 64. Moreover, those portions of the wheel 64 which are penetrated by the electrical conductors are sealed to maintain airtightness of the tire 62.

In the first embodiment, the first coil 71 and the second coil 72 are located so that they overlap each other when viewed from the central axis 61. Furthermore, when viewed along an axis passing through both the first and second coils 71 and 72, the interval G2 between the second coil 72 and the power reception coil 240 is narrower than the interval G1 between the first coil 71 and the power transmission coil 40. As shown in FIG. 3, the tire 62 is in contact with the road 105 and thus deformed by irregularities of the road 105. If the first coil 71 was present in the deformed region, the first coil 71 would be affected by the deformation of the tire 62. Therefore, the interval G1 of a certain size is required between the first coil 71 and an outer edge of the tire 62. In contrast, the relative position between the power reception coil 240 and the tired wheel 60 remains unchanged without being affected by irregularities of the road 105. Therefore, the interval G2 between the second coil 72 and the power reception coil 240 can be set to be narrow. In fact, the interval G2 between the second coil 72 and the power reception coil 240 is set to be narrower than the interval G1 between the first coil 71 and the power transmission coil 40. Setting the interval G2 between the second coil 72 and the power reception coil 240 to be narrow, the efficiency of electric power transfer from the second coil 72 to the power reception coil 240 can be improved.

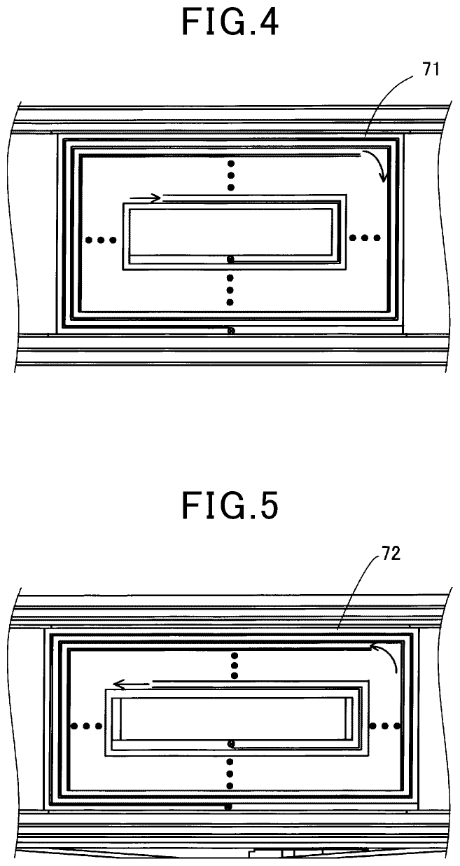

FIG. 4 is a diagram showing the first coil 71 viewed from the central axis 61 of the tired wheel 60. FIG. 5 is a diagram showing the second coil 72 viewed from the central axis 61 of the tired wheel 60. It should be noted that: illustration of the first coil 71 is partially omitted from FIG. 4; and illustration of the second coil 72 is partially omitted from FIG. 5. As shown in FIGS. 4 and 5, each of the first and second coils 71 and 72 is spirally wound. The number of turns of the first coil 71 and the number of turns of the second coil 72 are determined based on desired values of the inductances of the first coil 71 and the second coil 72. More particularly, in the first embodiment, the number of turns of the first coil 71 and the number of turns of the second coil 72 are set to be about 5 to 10 turns. Moreover, when clockwise induced current as viewed from the central axis 61 flows through the first coil 71 as shown in FIG. 4, counterclockwise induced current as viewed from the central axis 61 flows through the second coil 72 as shown in FIG. 5. Conversely, when counterclockwise induced current as viewed from the central axis 61 flows through the first coil 71, clockwise induced current as viewed from the central axis 61 flows through the second coil 72. Since the first and second coils 71 and 72 are located so that they overlap each other when viewed from the central axis 61, magnetic fields generated by the currents respectively flowing through the first and second coils 71 and 72 can cancel each other out, thereby suppressing leakage electromagnetic fields.

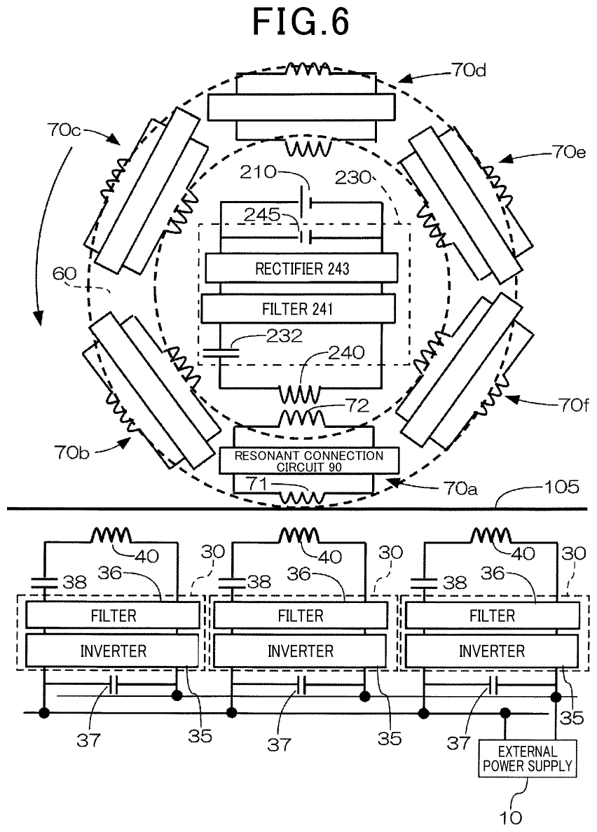

FIG. 6 is a schematic circuit diagram illustrating the electrical configuration of the power transfer system 500. Each of the power transmission circuits 30 operates upon receiving electric power supplied from the power supply 10. Each of the power transmission circuits 30 includes an inverter 35 and a filter 36. In the present embodiment, the filter 36 is configured as an immittance converter that functions as a band-pass filter. Moreover, each of the power transmission circuits 30 has a smoothing capacitor 37 on the electric power input side, and both a resonance capacitor 38 and the corresponding power transmission coil 40 on the electric power output side. In the first embodiment, an SS mode is employed in which the corresponding power transmission coil 40 and the resonance capacitor 38 are connected in series with each other. It should be noted that instead of the SS mode, a PP mode or an SPS mode may be employed. In the PP mode, the corresponding power transmission coil 40 and the resonance capacitor 38 are connected in parallel with each other. In the SPS mode, the corresponding power transmission coil 40 has both a resonance capacitor connected in series therewith and a resonance capacitor connected in parallel therewith.

The power reception circuit 230, which receives electric power via the relay coils 70 provided in the tired wheel 60, includes a resonance capacitor 232 connected in series with the power reception coil 240, a filter 241, a rectifier 243 that performs full-wave rectification, and a smoothing capacitor 245. In the present embodiment, the filter 241 is also configured as an immittance converter. The electric power received by the power reception circuit 230 is converted to DC power by the rectifier 243; and the DC power is then used to charge the main battery 210. The voltage of the main battery 210 is arbitrary; for example, 100V or 400V may be used as the voltage of the main battery 210. Therefore, if necessary, a DC/DC converter compatible with the voltages of both the rectifier 243 and the main battery 210 may be provided between them.

As shown in FIG. 6, in the present embodiment, in each of the tired wheels 60, the six relay coils 70 are arranged at central angle intervals of 60° along the circumferential direction of the tired wheel 60. As described above, each of the relay coils 70a to 70f includes the first coil 71, the second coil 72, and the resonant connection circuit 90 that connects the two coils 71 and 72. It should be noted that in each of the tired wheels 60, there may be provided only one relay coil 70 or a plurality of relay coils 70; i.e., the number of the relay coils 70 provided in each of the tired wheels 60 may be arbitrarily set. When each of the tired wheels 60 rotates, the relay coils 70 provided in the tired wheel 60 also rotate so that the first coil 71 facing the road 105 is successively switched and the power transmission coil 40 facing the first coil 71 is also successively switched. Moreover, the second coil 72 facing the power reception coil 240 is also successively switched. In each of the relay coils 70, the resonant connection circuit 90 is configured to satisfy the following two conditions. The first condition is that the resonance frequency of the circuit including the first coil 71 of the relay coil 70 which has reached a position facing one of the power transmission coils 40 be close to the frequency of the AC power supply applied to the power transmission coil 40. The second condition is that the resonance frequency of the circuit including the second coil 72 of the relay coil 70 which has reached a position facing the power reception coil 240 be close to the resonance frequency of the circuit formed by the resonance capacitor 232 and the reception circuit 230. The resonance frequencies are determined by the self-inductances of the first and second coils 71 and 72 due to magnetic fluxes respectively passing through the first and second coils 71 and 72 at that time, the capacitances of resonance capacitors included in the resonant connection circuit 90, etc. In the present embodiment, the resonance frequencies are set to be approximately 85 kHz. The configuration of the resonant connection circuit 90 will be described in detail later.

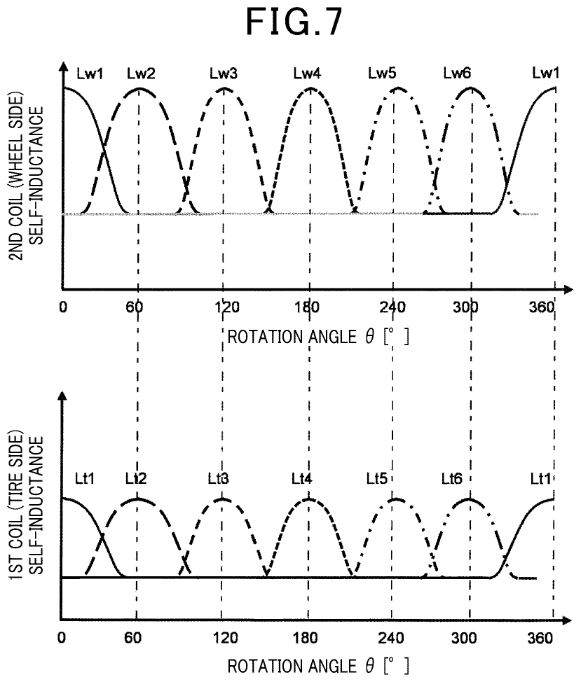

FIG. 7 is an explanatory diagram illustrating the relationship between the phase of one of the tired wheels 60 and the self-inductances of the first and second coils 71 and 72 of the relay coils 70 provided in the tired wheel 60. As shown in the lower part of the FIG. 7, for each of the relay coils 70, the self-inductance of the first coil 71 of the relay coil 70 becomes highest when the first coil 71 faces one of the power transmission coils 40. Specifically, at the phase of 0°, the first coil 71a of the relay coil 70a faces the power transmission coil 40 and thus the self-inductance Lt1 of the first coil 71a becomes highest. Similarly, at the phase of 60°, the first coil 71b of the relay coil 70b faces the power transmission coil 40 and thus the self-inductance Lt2 of the relay coil 70b becomes highest. At the phase of 120°, the first coil 71c of the relay coil 70c faces the power transmission coil 40; and at the phase of 180°, the first coil 71d of the relay coil 70d faces the power transmission coil 40. Thus, the self-inductance Lt3 of the relay coil 70c and the self-inductance Lt4 of the relay coil 70d become highest respectively at the phases of 120° and 180°. That is, the self-inductances Lt1 to Lt4 of the first coils 71a to 71d of the relay coils 70a to 70d become highest and the first coils 71a to 71d are most coupled to the power transmission coil 40 respectively at the phases of 0°, 60°, 120° and 180°. The same applies to the relay coils 70e and 70f.

On the other hand, as shown in the upper part of FIG. 7, the self-inductances Lw1 to Lw6 of the second coils 72a to 72f of the relay coils 70a to 70f become highest respectively at the phases of 0°, 60°, 120°, 180°, 240°, 300° and 360° where the second coils 72a to 72f respectively reach a position facing the power reception coil 240. In addition, the power transmission coils 40 and the power reception coil 240 each include a magnetic body; therefore, when the first and second coils 71 and 72 of any of the relay coils 70 respectively approach one of the power transmission coils 40 and the power reception coil 240, the inductances of the first and second coils 71 and 72 change significantly due to the magnetic bodies included in the power transmission coil 40 and the power reception coil 240. It is preferable to determine the capacitances of the resonance capacitors, which will be described later, using the maximum values of the changing inductances of the first and second coils 71 and 72. It should be noted that: either the power transmission coils 40 or the power reception coil 240 may have no magnetic body provided therein; alternatively, all of the power transmission coils 40 and the power reception coil 240 may have no magnetic body provided therein.

Focusing on one of the relay coils 70, when the first coil 71 of the relay coil 70 faces one of the power transmission coils 40, the self-inductance of the first coil 71 becomes highest. The capacitances of the resonance capacitors (to be described later) provided in the resonant connection circuit 90 are set, using the maximum value of the self-inductance of the first coil 71, so that the resonance frequency of the first coil 71 is equal or close to the frequency of the AC voltage applied to the transmission coil 40. In addition, at this time, the resonance frequency may be calculated assuming that the impedance of the circuit including the first coil 71 is sufficiently low, or be determined by actual measurement; then, the capacitances of the resonance capacitors may be set based on the resonance frequency. Similarly, if the impedance of the circuit including the second coil 72 is sufficiently low, the resonance frequency of the second coil 72 is determined by the self-inductance of the second coil 72 when the second coil 72 faces the power reception coil 240 and the capacitances of the resonance capacitors. Therefore, the capacitances of the resonance capacitors are set so that the resonance frequency of the second coil 72 is equal or close to the designed frequency at which the power reception coil 240 receives electric power. In the present embodiment, when the first coil 71 faces one of the power transmission coils 40, the second coil 72 reaches a position facing the power reception coil 240. Therefore, both the coupling coefficient ka between the power transmission coil 40 and the first coil 71 and the coupling coefficient kb between the second coil 72 and the power reception coil 240 can be maximized. As a result, the efficiency of electric power transmission from the power transmission coil 40 to the power reception coil 240 via the relay coil 70 can be improved.

### A4. Configuration and Function of Relay Resonant Circuit

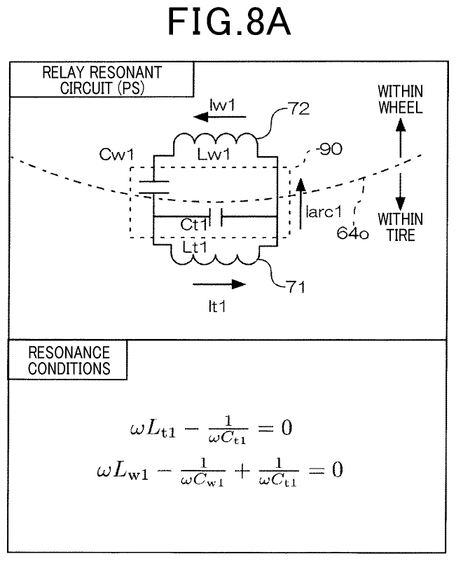

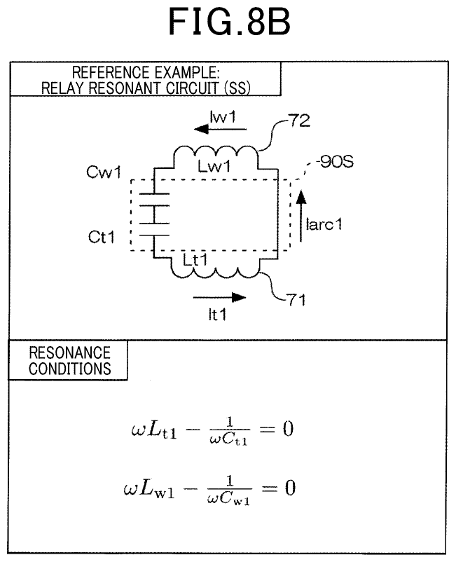

Hereinafter, the configuration and function of the relay resonant circuit 90 according to the first embodiment will be described. FIG. 8A illustrates the configuration of the relay resonant circuit 90 according to the first embodiment. The relay resonant circuit 90 according to the first embodiment has a parallel resonance capacitor Ct1 connected in parallel with the first coil 71 and a series resonance capacitor Cw1 connected in series with the second coil 72. The resonance mode of the relay resonant circuit 90 according to the first embodiment will be referred to a PS resonance mode. In contrast, as shown in FIG. 8B, a relay resonant circuit 90S according to a reference example has both resonance capacitors Ct1 and Cw1 connected in series with the first coil 71 and the second coil 72. The resonance mode of the relay resonant circuit 90S according to the reference example will be referred to as an SS resonance mode (or series mode).

Hereinafter, the reference signs Ct1 and Cw1, which designate the capacitors, will also represent the capacitances of the capacitors. The reference signs Lt1 and It1 respectively represent the inductance and current of the first coil 71. The reference signs Lw1 and Iw1 respectively represent the inductance and current of the second coil 72. The suffix t added to the capacitance C of the capacitor, the inductance L of the coil, the current I flowing through the coil, etc. denotes the tire side, i.e., the first coil 71 side. In contrast, the suffix w added to the capacitance C of the capacitor, the inductance L of the coil, the current I flowing through the coil, etc. denotes the wheel side, i.e., the second coil 72 side. The reference sign Iarc represents the resonance current.

As shown in the upper part of FIG. 8A, the first coil 71 and the parallel resonance capacitor Ct1 are provided outside the outer periphery 640 of the wheel 64, i.e., within the tire 62. In contrast, the second coil 72 and the series resonance capacitor Cw1 are provided within the wheel 64. Moreover, as already described, in the first embodiment, the parallel resonance capacitor Ct1 is mounted to the thermally-conductive plate 80.

In the lower part of FIG. 8A, there are shown equations representing the resonance conditions of the relay resonant circuit 90 in the PS resonance mode according to the first embodiment. In the PS resonance mode, the frequency F (ω=2πF) that satisfies the following equations becomes the resonance frequency.

ω·Lt1−1/(ω·Ct1)=0

ω·Lw1−1/(ω·Cw1)+1/(ω·Ct1)=0

In contrast, in the lower part of FIG. 8B, there are shown equations representing the resonance conditions of the relay resonant circuit 90S in the SS resonance mode according to the reference example. In the SS resonance mode, the frequency F (ω=2πF) that satisfies the following equations becomes the resonance frequency.

ω·Lt1−1/(ω·Ct1)=0

ω·Lw1−1/(ω·Cw1)=0

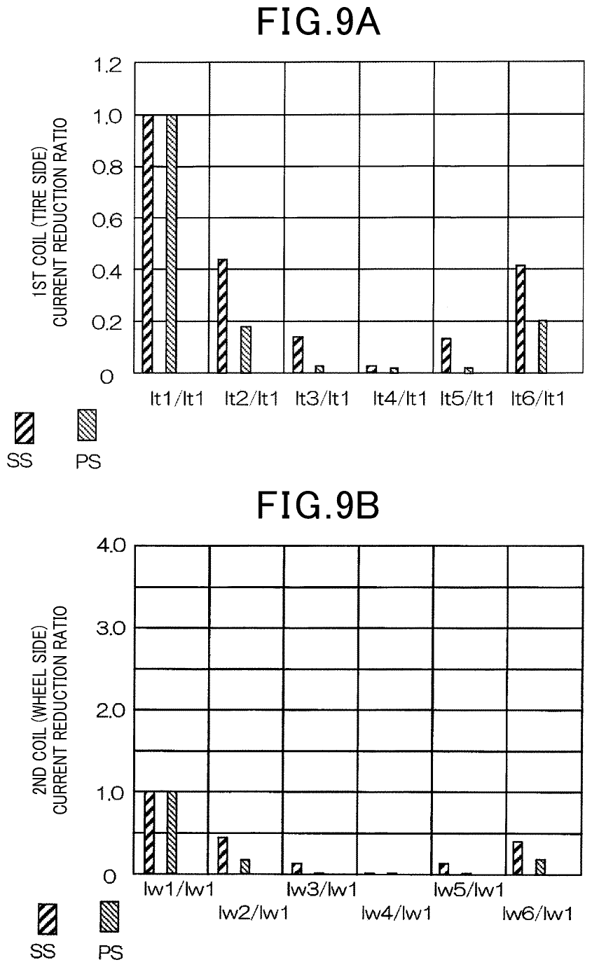

In the first embodiment, the relay resonant circuit 90 employs the PS resonance mode and each of the relay coils 70 has a parallel characteristic. Various characteristics relating to electric power supply using the relay coils 70 in the PS resonance mode are shown in FIGS. 9A, 9B, 10 and 11 in comparison with the SS resonance mode according to the reference example. FIG. 9A shows, through normalization, currents flowing respectively through the first coils 71b to 71f of the relay coils 70b to 70f when the relay coil 70a, among the six relay coils 70a to 70f provided at phase intervals of 60°, faces one of the power transmission coils 40. In FIG. 9A, the vertical axis represents the current reduction ratio. More specifically, in FIG. 9A, the current It1 flowing through the first coil 71a on the tire side is normalized to the same magnitude of 1.0 in both the SS resonance mode and the PS resonance mode; and the currents It2 to It6 flowing respectively through the first coils 71b to 71f are shown as the ratios It2/It1 to It6/It1 to the current It1 flowing through the first coil 71a. In addition, in FIG. 9A, the vertical axis is set to represent the current reduction ratio because the currents It2 to It6 flowing respectively through the first coils 71b to 71f are shown as the ratios thereof to the current It1 flowing through first coil 71a that directly faces one of the power transmission coils 40. Therefore, for each of the first coils 71b to 71f, a lower current reduction ratio indicates less unnecessary current flowing through the first coil.

Similarly, FIG. 9B shows the currents flowing respectively through the second coils 72b to 72f of the relay coils 70b to 70f when the relay coil 70a, among the six relay coils 70a to 70f provided at phase intervals of 60°, directly faces one of the power transmission coils 40. In FIG. 9B, the vertical axis represents the current reduction ratio. More specifically, in FIG. 9B, the current Iw1 flowing through the second coil 72a on the wheel side is normalized to the same magnitude of 1.0 in both the SS resonance mode and the PS resonance mode; and the currents Iw2 to Iw6 flowing respectively through the second coils 72b to 72f are shown as the ratios Iw2/Iw1 to Iw6/Iw1 to the current Iw1 flowing through the second coil 71a. In addition, for each of the second coils 72b to 72f, a lower current reduction ratio indicates less unnecessary current flowing through the second coil.

Since electric power is supplied from one of the transmission coils 40 to the power reception coil 240, it is ideal that current flows through only that one of the relay coils 70 which directly faces the power transmission coil 40, more particularly only the relay coil 70a in the state shown in FIG. 6, and no current flows through the other relay coils 70b to 70f. However, in reality, currents are also generated in the other relay coils 70b to 70f. These currents are consumed as wasted electric power that does not contribute to the electric power supply, and actually converted into heat.

In the present embodiment, the relay resonant circuit 90 employs the PS resonant mode and has the parallel characteristic. Consequently, as shown in FIGS. 9A and 9B, in the PS resonant mode, the current reduction ratios become lower in both the first coil and the second coil in the other relay coils 70b to 70f than in the SS resonance mode. That is, in the PS resonant mode, wasted electric power consumption becomes less than in the SS resonance mode. Hence, in the PS resonant mode, heat generation in the tire 62 and the wheel 64 is suppressed, thereby making it possible to suppress increase in the temperatures in these locations. In general, the tire 62 and the wheel 64 are enclosed spaces and have no cooling means; therefore, the effect of suppressing heat generation therein is significant.

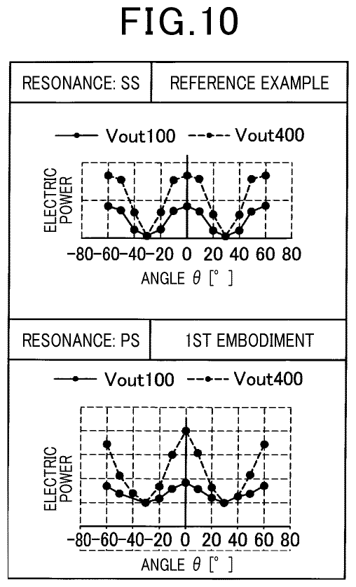

FIG. 10 is an explanatory diagram showing the phase change of electric power during the electric power supply in the SS resonance mode according to the reference example and the PS resonance mode according to the present embodiment. In FIG. 10, the solid lines indicate electric power supplied with the power supply voltage (i.e., the charging voltage of the main battery 210) being 100V, whereas the dashed lines indicate electric power supplied with the power supply voltage being 400V. Moreover, in FIG. 10, there is shown change in the supplied electric power, with the angle θ being 0° when one of the relay coils 70 directly faces one of the power transmission coils 40, within the phase range of ±60°, i.e., within a phase range corresponding to ⅓ rotation of the wired wheel 60. As shown in FIG. 10, when the voltage used for electric power supply changes, in the SS resonance mode, the peak electric power supplied plateaus; in contrast, in the PS resonance mode, electric power corresponding to the theoretical current quantity shown in FIG. 7 is supplied.

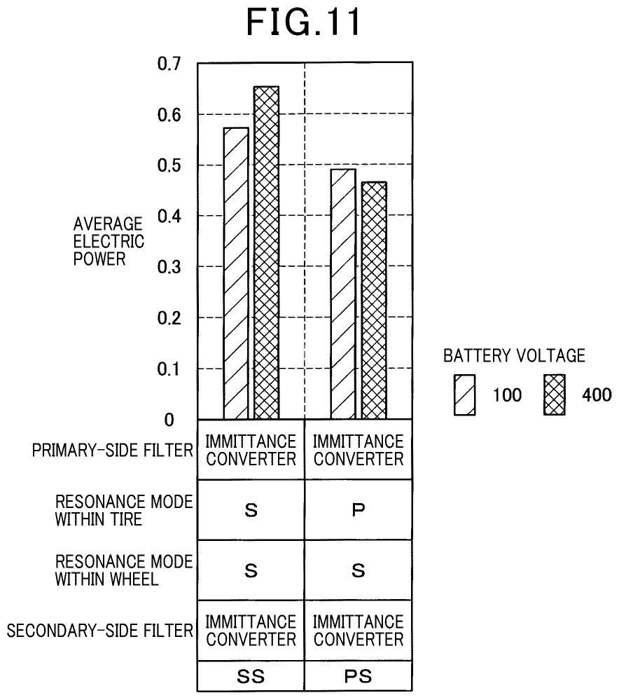

FIG. 11 is an explanatory diagram giving a comparison in average electric power supplied between the SS resonance mode according to the reference example and the PS resonance mode according to the present embodiment. It should be noted that in FIG. 11, the primary-side filter is the filter 36 shown in FIG. 6, whereas the secondary-side filter is the filter 241 shown in FIG. 6. Moreover, each of the filters 36 and 241 is implemented by an immittance converter that is two-terminal pair circuit in which the impedance seen from one terminal pair is proportional to the admittance of a circuit or an element connected to the other terminal pair. Although the use of such an immittance converter causes some loss, it functions as a noise filter and improves the conversion characteristics between the coils.

As shown in FIG. 11, in both the case of the charging voltage of the main battery 210 being 100V and the case of the charging voltage of the main battery 210 being 400V, the average electric power supplied from the road side to the vehicle 200 is lower in the PS resonance mode according to the present embodiment than in the SS resonance mode according to the reference example. On the other hand, as shown in FIG. 9A, the currents flowing through the first coils 71 of the relay coils 70 not directly facing the power transmission coil 40 (hereinafter, to be referred to as the non-facing relay coils 70) are lower in the PS resonance mode according to the present embodiment than in the SS resonance mode according to the reference example. Therefore, even if the average electric power supplied via the relay coils 70 in the PS resonance mode is lower than or equal to that in the SS resonance mode as shown in FIG. 11, it will still be possible to suppress loss due to the currents flowing through the non-facing relay coils 70 that are not directly involved in the transfer of electric power from the power transmission coil 40 to the power reception coil 240. Consequently, a suitable efficiency of the overall power transfer system 500 can be achieved. In particular, by reducing the currents flowing through the non-facing relay coils 70, heat generation due to the loss in the non-facing relay coils 70 can be suppressed; thus, increase in the temperature in the space within the tired wheel 60, which is an enclosed space and not easy to cool, can be suppressed.

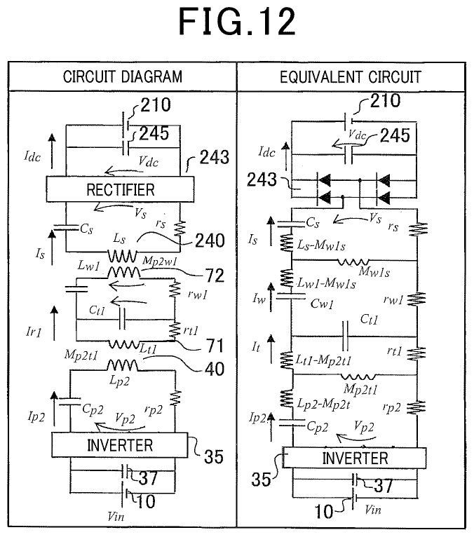

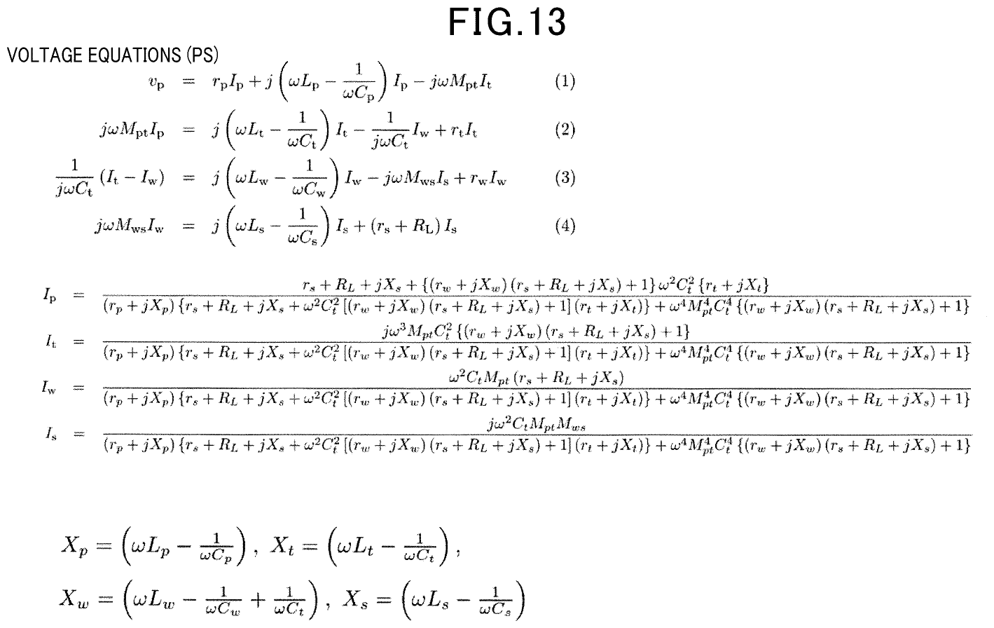

FIG. 12 illustrates the circuit configuration in the case of employing the PS resonance mode and its equivalent circuit. In the equivalent circuit, the coupling between the power transmission coil 40 and the first coil 71 of the relay coil 70 is divided into the mutual inductance Mp2t1 between the two coils and the self-inductances of the two coils. Similarly, the coupling between the second coil 72 of the relay coil 70 and the power reception coil 240 is divided into the mutual inductance Mw1s between the two coils and the self-inductances of the two coils. Moreover, voltage equations (1) to (4) are formulated from the equivalent circuit; then, these voltage equations are solved to determine the currents Ip, It, Iw and Is, from which the resonance conditions are determined as shown in FIG. 13. It should be noted that in the equivalent circuit, the influence of the relay coils 70 (i.e., the non-facing relay coils 70) other than the relay coil 70 that faces the power transmission coil 40 and the power reception coil 240 is not taken into account.

### A5. Advantageous Effects Achievable According to First Embodiment

According to the first embodiment described above, each of the relay resonant circuits 90 of the relay coils 70 is configured to employ, in the supply of electric power using the relay coils 70, the PS resonant mode in which the resonance capacitors have the parallel characteristic (see FIG. 8A). Consequently, it becomes possible to suppress currents flowing respectively through, of the plurality of relay coils 70 arranged in the tired wheel 60, those relay coils 70 (e.g., the relay coils 70b to 70f) other than the relay coil 70 (e.g., the relay coil 70a) that directly faces one of the power transmission coils 40 and the power reception coil 240 and is thus involved in the supply of electric power from the one of the power transmission coils 40 to the power reception coil 240. As a result, it becomes possible to increase the average electric power supplied via the relay coils 70, thereby improving the efficiency of the power transfer system 500.

Moreover, according to the first embodiment, each of the relay coils 70 is arranged in the tired wheel 60 so as to be located between the power transmission coils 40 and the power reception coil 240; and each of the first coils 71 of the relay coils 70 is arranged outside the wheel 64 and within the tire 62. Consequently, it becomes possible to reduce the interval G1 (see FIG. 3) between each of the first coils 71 of the relay coils 70 and the power transmission coils 40 embedded in the road 105. On the other hand, the second coils 72 of the relay coils 70 and the power reception coil 240 are each arranged within the wheel 64. Consequently, it also becomes possible to reduce the interval G2 (see FIG. 3) between each of the second coils 72 of the relay coils 70 and the power reception coil 240. Hence, according to the first embodiment, by separating each of the relay coils 70 into the first coil 71 and the second coil 72, it becomes possible to reduce both the interval G1 between the power transmission coils 40 and the first coil 71 and the interval G2 between the second coil 72 and the power reception coil 240. In addition, since the first coil 71 and the second coil 72 are directly connected via the relay resonant circuit 90 in each of the relay coils 70, loss occurring therebetween is extremely low. As a result, it becomes possible to improve the total efficiency of electric power transfer from the power transmission coils 40 to the power reception coil 240.

Furthermore, according to the first embodiment, when viewed from the central axis 61 of the tired wheel 60, the direction of the induced current flowing through the first coil 71 and the direction of the induced current flowing through the second coil 72 are opposite to each other (see FIGS. 4 and 5). Consequently, it becomes possible to suppress leakage electromagnetic fields. It should be noted that the direction of the induced current flowing through the first coil 71 and the direction of the induced current flowing through the second coil 72 may not be opposite to each other when viewed from the central axis 61 of the tired wheel 60. In addition, depending on the arrangement of the first coil 71 and the second coil 72, the directions of magnetic fields generated by the two coils may be the same as or opposite to each other.

### B. Second to Fourth Embodiments

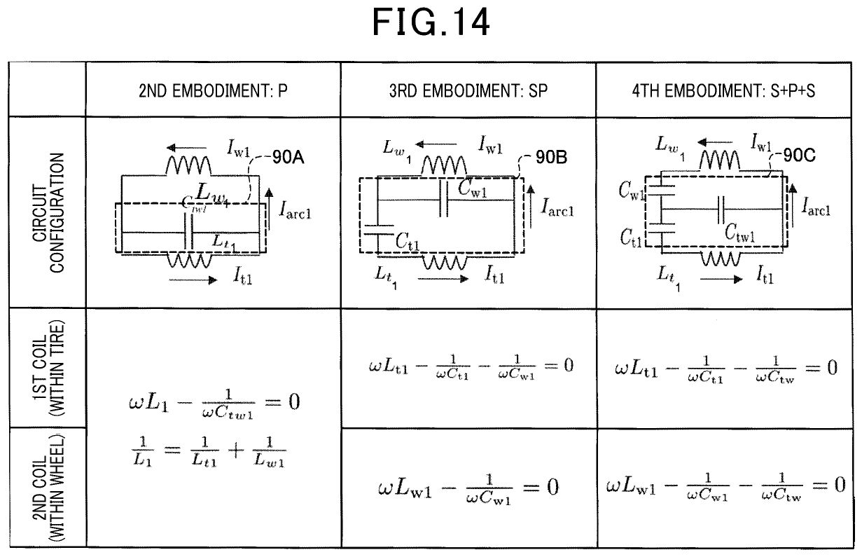

Next, the second to fourth embodiments will be described. The power transfer systems 500 and the power supply apparatuses 250 according to the second to fourth embodiments are identical to those according to the first embodiment except for the configurations of the relay resonant circuits 90. FIG. 14 shows the configurations of the relay resonant circuits 90A to 90C of the relay coils 70 according to the second to fourth embodiments. As shown in FIG. 14, the relay resonant circuit 90A according to the second embodiment has a parallel resonance capacitor Ctw1 connected in parallel with each of the first coil 71 and the second coil 72. However, no series resonance capacitor is provided in the relay resonant circuit 90A. Therefore, the relay resonant circuit 90A also has a parallel characteristic. The resonance mode of the relay resonant circuit 90A according to the second embodiment will be referred to as a P resonance mode. The resonance conditions of the relay resonant circuit 90A in the P resonance mode are shown in the lower part of the column for the second embodiment in FIG. 14.

Moreover, as shown in FIG. 14, the relay resonant circuit 90B according to the third embodiment has a series resonance capacitor Ct1 connected in series with the first coil 71 and a parallel resonance capacitor Cw1 connected in parallel with the second coil 72. Therefore, the relay resonant circuit 90B also has a parallel characteristic. The resonance mode of the relay resonant circuit 90B according to the third embodiment will be referred to as an SP resonance mode. The resonance conditions of the relay resonant circuit 90B in the SP resonance mode are shown in the lower part of the column for the third embodiment in FIG. 14.

Furthermore, as shown in the FIG. 14, the relay resonant circuit 90C according to the fourth embodiment has: a first series resonance capacitor Ct1 connected in series with the first coil 71; a second series resonance capacitor Cw1 connected in series with the second coil 72; and a parallel resonance capacitor Ctw1 connected in parallel with the first coil 71 and the first series resonance capacitor Ct1 and in parallel with the second coil 72 and the second series resonance capacitor Cw1. Therefore, the relay resonant circuit 90C also has a parallel characteristic. The resonance mode of the relay resonant circuit 90C according to the fourth embodiment will be referred to as an S+P+S (hereinafter, abbreviated to SPS) resonance mode. The resonance conditions of the relay resonant circuit 90C in the SPS mode are shown in the lower part of the column for the fourth embodiment in FIG. 14.

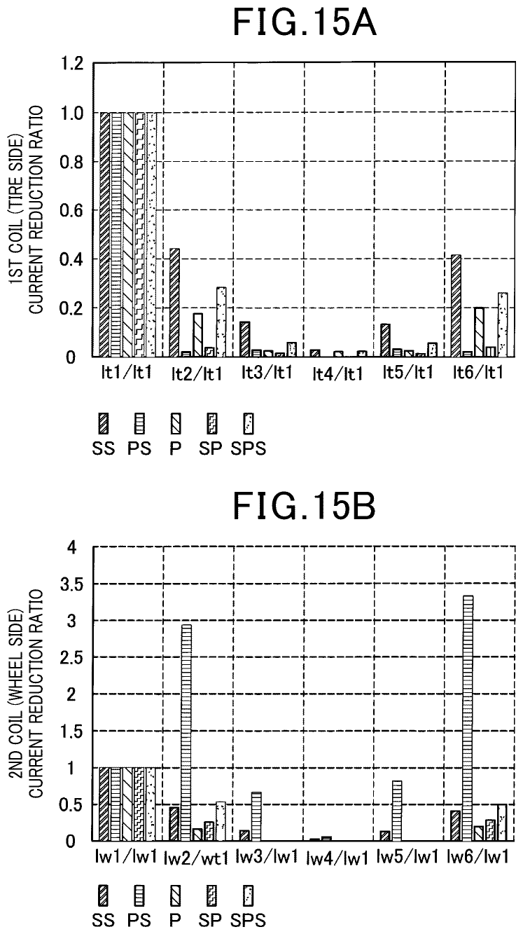

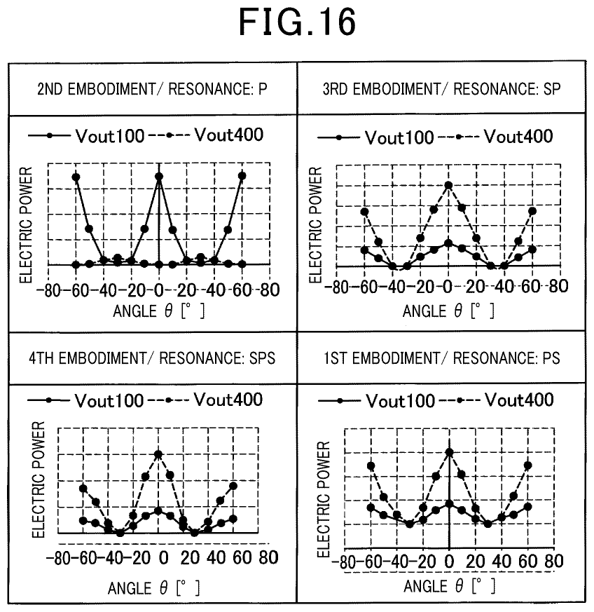

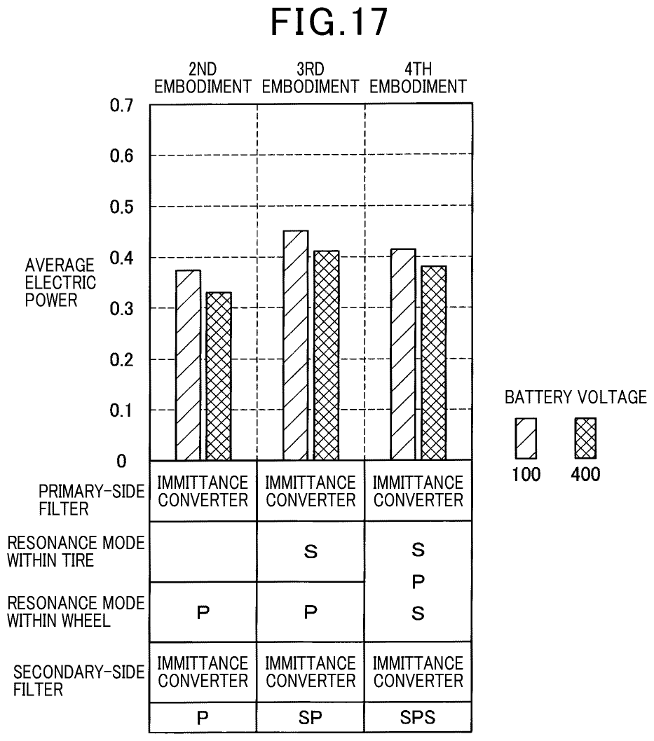

FIGS. 15A and 15B show the current reduction ratios of the first and second coils 71 and 72 according to the second to fourth embodiments. FIG. 16 shows the phase change of electric power supplied according to the second to fourth embodiments. FIG. 17 shows the average electric power supplied according to the second to fourth embodiments. As shown in FIG. 15A, the currents flowing respectively through the first coils 71 of the non-facing relay coils 70 are lower in each of the resonance modes according to the second to fourth embodiments than in the SS resonance mode according to the reference example. Consequently, as shown in FIG. 17, in each of the resonance modes according to the second to fourth embodiments, it becomes possible to suppress loss due to the currents flowing through the non-facing relay coils 70 that are not directly involved in the transfer of electric power from the power transmission coil 40 to the power reception coil 240. That is, in each of the resonance modes according to the second to fourth embodiments, even if the average electric power supplied via the relay coils 70 is lower than or equal to that in the SS resonance mode, a suitable efficiency of the overall power transfer system 500 can still be achieved. Moreover, by reducing the currents flowing through the non-facing relay coils 70, heat generation due to the loss in the non-facing relay coils 70 can be suppressed. Consequently, in each of the resonance modes according to the second to fourth embodiments, increase in the temperature in the space within the tired wheel 60, which is an enclosed space and not easy to cool, can be suppressed as in the PS resonance mode according to the first embodiment.

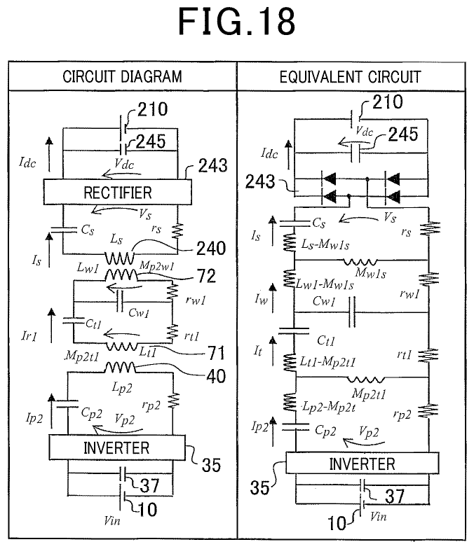

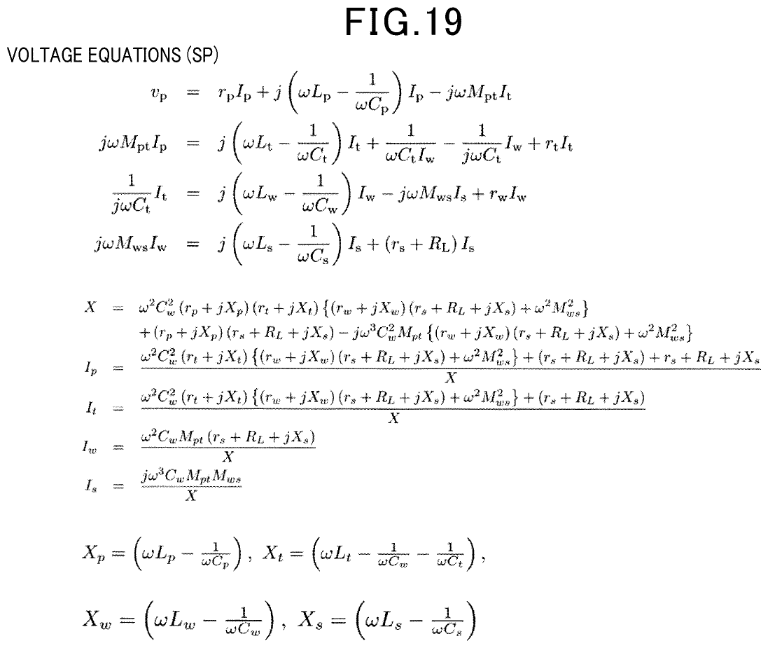

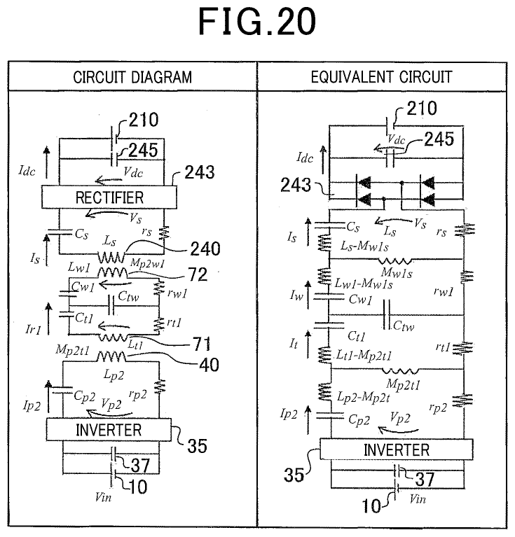

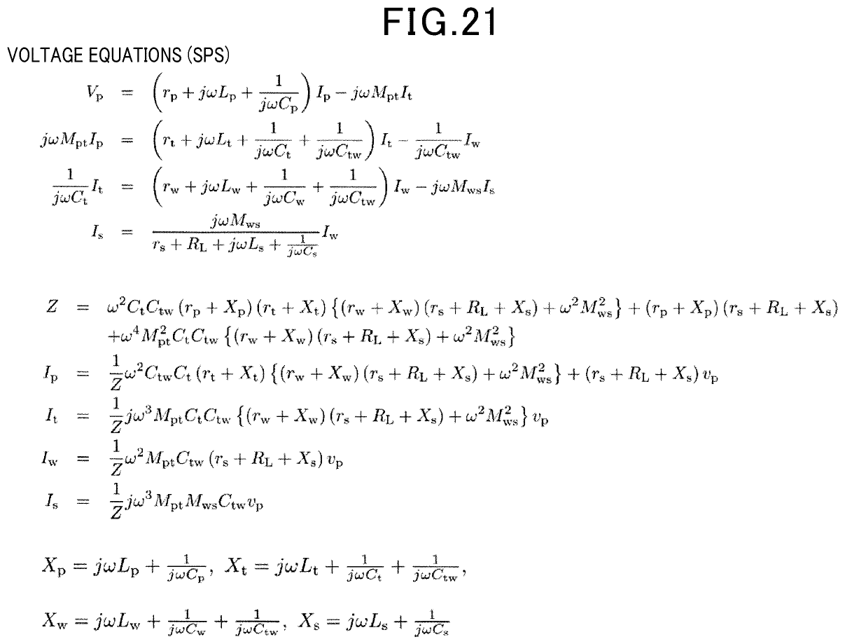

FIG. 18 illustrates the circuit configuration in the case of employing the SP resonance mode according to the third embodiment and its equivalent circuit. FIG. 20 illustrates the circuit configuration in the case of employing the SPS resonance mode according to the fourth embodiment and its equivalent circuit. The concept of the equivalent circuits according to the third and fourth embodiments is the same as that of the equivalent circuit according to the first embodiment (see FIG. 12). Moreover, voltage equations are formulated from the equivalent circuits according to the third and fourth embodiments; then, these voltage equations are solved to determine the currents Ip, It, Iw and Is, from which the resonance conditions are determined as shown in FIGS. 19 and 21. It should be noted that in the equivalent circuits according to the third and fourth embodiments as well, the influence of the non-facing relay coils 70 is not taken into account.

### C. Fifth to Seventh Embodiments

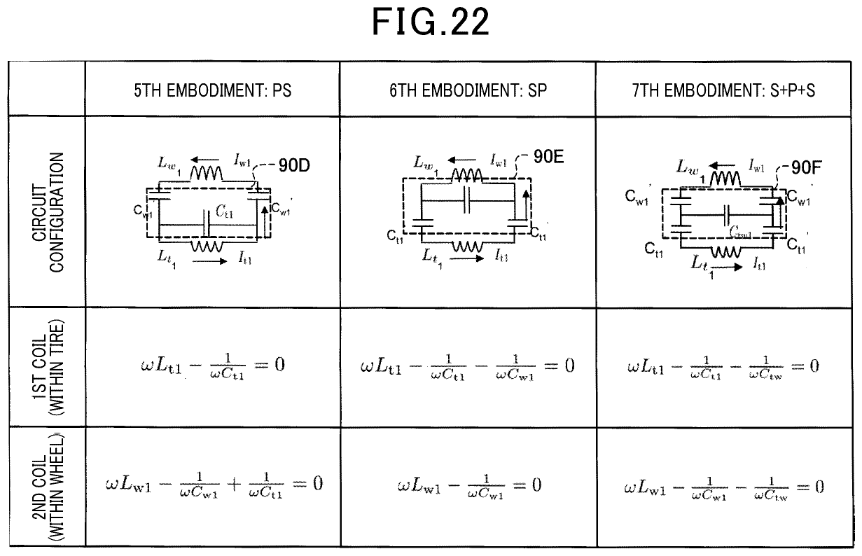

Next, the fifth to seventh embodiments will be described. The power transfer systems 500 and the power supply apparatuses 250 according to the fifth to seventh embodiments are identical to those according to the first, third and fourth embodiments except for the configurations of the relay resonant circuits 90. FIG. 22 shows the configurations of the relay resonant circuits 90D to 90F of the relay coils 70 according to the fifth to seventh embodiments. As shown in the FIG. 22, the relay resonant circuits 90D to 90F according to the fifth to seventh embodiments are respectively identical to the relay resonant circuits 90, 90B and 90C according to the first, third and fourth embodiments except that each of the series resonance capacitors Cw1 and Ct1 in the relay resonant circuits 90, 90B and 90C is divided into two series capacitors and the two series capacitors are arranged respectively on two sides of the first coil 71 and the second coil 72 in the relay resonant circuits 90D to 90F. Therefore, similar to the relay resonant circuits 90, 90B and 90C according to the first, third and fourth embodiments, each of the relay resonant circuits 90D to 90F according to the fifth to seventh embodiments also has a parallel characteristic. The resonance conditions of the relay resonant circuits 90D to 90F are shown in the lower parts of the columns respectively for the fifth to seventh embodiments in FIG. 22. In addition, the capacitances of the series resonance capacitors Cw1 and Ct1 may be divided equally or approximately equally so as to satisfy the resonance conditions. For example, the series resonance capacitor Ct1 may be divided into two series resonance capacitors Ct1′ such that Ct1=2·Ct1′.

The relay resonant circuits 90D to 90F according to the fifth to seventh embodiments each have the same advantageous effects as the relay resonant circuits 90, 90B and 90C according to the first, third and fourth embodiments. Moreover, the relay resonant circuits 90D to 90F according to the fifth to seventh embodiments each further have an advantageous effect of improving noise resistance. In addition, the power transfer systems 500 employing these relay resonant circuits 90D to 90F each have the same advantageous effects as those according to the first, third and fourth embodiments.

### D. Eighth Embodiment

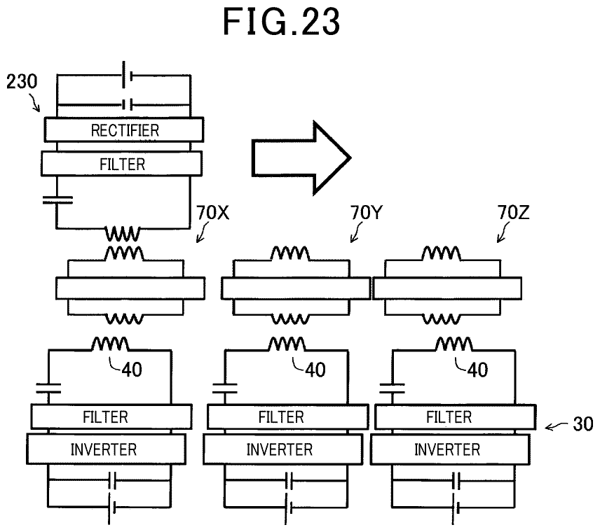

In the above-described embodiments, a plurality of relay coils 70 are arranged on a concentric circle of the central axis 61 of a tired wheel 60 of the vehicle 200, and configured to receive electric power supplied from the power transmission circuits 30 on the ground side. On the other hand, in the case of a plurality of relay coils 70 being linearly arranged, it is also possible to suppress currents flowing through the non-facing relay coils 70, thereby achieving the same advantageous effects as achievable according to the above-described embodiments. Specifically, as shown in FIG. 23, according to the eighth embodiment, relay coils 70X to 70Z are linearly arranged between a power reception coil 240 of a power reception circuit 230 provided in a moving object and the power transmission coils 40 on the ground side. It should be noted that the number of relay coils 70 is not limited to three, as in the first embodiment.

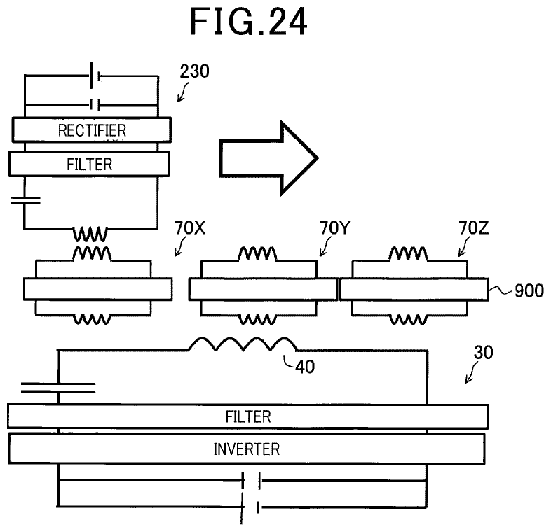

In the eighth embodiment, the ground-side power transmission circuits 30 and power transmission coils 40 are provided to respectively match the relay coils 70X to 70Z. In contrast, in a modification shown in FIG. 24, only one power transmission circuit 30 and only one power transmission coil 40 are provided for a plurality of relay coils 70X. In addition, the linear arrangement of relay coils 70 may be applied, for example, to a straight part of a tracked vehicle in which steel plates are connected in a band shape to surround front and rear wheels, or to a linear motor of a robot.

### E. Configuration Examples

(1) According to a first aspect of the present disclosure, a power supply apparatus is provided. The power supply apparatus includes a power reception coil, a plurality of relay coils and a power reception circuit. The power reception coil is mounted to a moving object. The plurality of relay coils are configured to successively relay supply of electric power from a power transmission coil to the power reception coil during movement of the moving object; the power transmission coil is arranged along a surface on which the moving object moves. The power reception circuit is connected with the power reception coil to receive the electric power for use in the moving object. Moreover, each of the plurality of relay coils includes a first coil configured to be magnetic-field-coupled to the power transmission coil according to movement position of the moving object, a second coil configured to be magnetic-field-coupled to the power reception coil when the first coil is magnetic-field-coupled to the power transmission coil, and a connection circuit that connects the first coil and the second coil. The connection circuit includes at least one resonance capacitor involved in setting of a resonance frequency of at least one of the first coil and the second coil. The at least one resonance capacitor has a parallel characteristic. With the above configuration, it becomes possible to reduce, for each of the plurality of relay coils, both the interval between the power transmission coil and the first coil of the relay coil and the interval between the second coil of the relay coil and the power reception coil. Consequently, it becomes possible to improve the efficiency of electric power transfer from the power transmission coil to the power reception coil. Moreover, due to the parallel characteristic of the at least one resonance capacitor involved in setting of a resonance frequency of at least one of the first coil and the second coil, it becomes possible to suppress currents flowing respectively through those of the plurality of relay coils which do not directly face the power transmission coil. As a result, it becomes possible to improve the electric power supply efficiency of the power supply apparatus.

If the impedance of the circuit including the first coil is sufficiently low, the resonance frequency of the first coil is determined by the inductance of the first coil when the first coil faces the power transmission coil and the capacitance of the at least one resonance capacitor. Therefore, the capacitance of the at least one resonance capacitor may be set so that the resonance frequency of the first coil is equal or close to the frequency of the electric power transmitted from the power transmission coil. Similarly, if the impedance of the circuit including the second coil is sufficiently low, the resonance frequency of the second coil is determined by the inductance of the second coil when the second coil faces the power reception coil and the capacitance of the at least one resonance capacitor. Therefore, the capacitance of the at least one resonance capacitor may be set so that the resonance frequency of the second coil is equal or close to the designed frequency at which the power reception coil receives electric power.

The power supply apparatus can be applied to various types of moving objects, such as wheeled vehicles and parallel-translating robots. A wheeled vehicle may have a single wheel or a plurality of wheels. The power supply apparatus can also be applied to tracked vehicles. Moreover, the surface on which the moving object moves may be a road surface or a floor surface, whether indoors or outdoors. A flat surface is preferable, but a curved surface or a surface with a slight step may also be acceptable. The surface on which the moving object moves is not necessarily a horizontal surface, but may be a wall surface or a ceiling surface as long as the moving object can be attracted to the surface by magnetic or electrostatic force and kept in contact with the surface. The plurality of relay coils may be arranged in a circumferential direction of a vehicle wheel or the like, or be arranged linearly. For example, the moving object may be levitated like a hovercraft; the plurality of relay coils may be arranged on the bottom surface of the moving object; and the moving object may receive electric power supplied via that one of the plurality of relay coils which directly faces the power transmission coil arranged along the surface on which the moving object moves. The number of relay coils is not limited to six shown in the above-described embodiments, but may be any number greater than one such as two, five or seven.

Each of the plurality of relay coils may further include one or more coils in addition to the first coil configured to be magnetic-field-coupled to the power transmission coil and the second coil configured to be magnetic-field-coupled to the power reception coil. The magnetic field coupling between the first coil and the power transmission coil and between the second coil and the power reception coil may or may not involve the intervention of a magnetic body.

(2) In the power supply apparatus, the at least one resonance capacitor may be a parallel resonance capacitor connected in parallel with each of the first coil and the second coil. In other words, a closed circuit may be formed by the first coil and the second coil; and a parallel resonance capacitor may be connected in parallel with each of the first coil and the second coil. In this case, it is possible to realize, with a simple configuration, the parallel characteristic of the at least one resonance capacitor. Consequently, it will become possible to achieve a balance between the suppression of currents flowing respectively through those of the plurality of relay coils which do not directly face the power transmission coil and the setting of resonance conditions. In addition, although the at least one resonance capacitor may be a single parallel resonance capacitor, from the viewpoint of noise countermeasures, the at least one resonance capacitor may alternatively include one parallel resonance capacitor on each of the first coil side and the second coil side.

(3) Alternatively, in the power supply apparatus, the at least one resonance capacitor may include a parallel resonance capacitor connected in parallel with the first coil, and a series resonance capacitor connected in series with the second coil. In this case, it is possible to impart parallel characteristics to the resonance between the first coil and the power transmission coil and series characteristics to the resonance between the second coil and the power reception coil. Consequently, it will become possible to achieve a balance between the suppression of currents flowing respectively through those of the plurality of relay coils which do not directly face the power transmission coil and the setting of resonance conditions. In addition, although the at least one resonance capacitor may include a single series resonance capacitor, from the viewpoint of noise countermeasures, the at least one resonance capacitor may alternatively include two series resonance capacitors provided respectively at two ends of the second coil.

(4) Further, in the above configuration example (3), the capacitances of the parallel resonance capacitor and the series resonance capacitor may be determined by the solutions of simultaneous equations consisting of: a first voltage equation taking into account a power transmission voltage applied to a circuit including the power transmission coil and a first capacitor for resonance, the inductance of the power transmission coil, the capacitance of the first capacitor, the mutual inductance between the power transmission coil and the first coil, and the circuit impedance; a second voltage equation taking into account the inductance of the first coil in a circuit including the first coil and the parallel resonance capacitor, the capacitance of the parallel resonance capacitor, the mutual inductance between the power transmission coil and the first coil, and the circuit impedance; a third voltage equation taking into account the inductance of the second coil in a circuit including the second coil, the parallel resonance capacitor and the series resonance capacitor, the capacitance of the parallel resonance capacitor, the capacitance of the series resonance capacitor, the mutual inductance between the second coil and the power reception coil, and the circuit impedance; and a fourth voltage equation taking into account the inductance of the power reception coil in a circuit including the power reception coil and a second capacitor for resonance, the capacitance of the second capacitor, the mutual inductance between the second coil and the power reception coil, and the circuit impedance. In this way, the capacitances of the parallel resonance capacitor and the series resonance capacitor can be set to proper values through theoretical analysis.

(5) Alternatively, in the power supply apparatus, the at least one resonance capacitor may include a series resonance capacitor connected in series with the first coil, and a parallel resonance capacitor connected in parallel with the second coil. In this case, it is possible to impart series characteristics to the resonance between the first coil and the power transmission coil and parallel characteristics to the resonance between the second coil and the power reception coil. Consequently, it will become possible to achieve a balance between the suppression of currents flowing respectively through those of the plurality of relay coils which do not directly face the power transmission coil and the setting of resonance conditions. In addition, although the at least one resonance capacitor may include a single series resonance capacitor, from the viewpoint of noise countermeasures, the at least one resonance capacitor may alternatively include two series resonance capacitors provided respectively at two ends of the first coil.

(6) Further, in the above configuration example (5), the capacitances of the series resonance capacitor and the parallel resonance capacitor may be determined by the solutions of simultaneous equations consisting of: a first voltage equation taking into account a power transmission voltage applied to a circuit including the power transmission coil and a first capacitor for resonance, the inductance of the power transmission coil, the capacitance of the first capacitor, the mutual inductance between the power transmission coil and the first coil, and the circuit impedance; a second voltage equation taking into account the inductance of the first coil in a circuit including the first coil, the series resonance capacitor and the parallel resonance capacitor, the capacitance of the series resonance capacitor, the capacitance of the parallel resonance capacitor, the mutual inductance between the power transmission coil and the first coil, and the circuit impedance; a third voltage equation taking into account the inductance of the second coil in a circuit including the second coil and the parallel resonance capacitor, the capacitance of the parallel resonance capacitor, the mutual inductance between the second coil and the power reception coil, and the circuit impedance; and a fourth voltage equation taking into account the inductance of the power reception coil in a circuit including the power reception coil and a second capacitor for resonance, the capacitance of the second capacitor, the mutual inductance between the second coil and the power reception coil, and the circuit impedance. In this way, the capacitances of the series resonance capacitor and the parallel resonance capacitor can be set to proper values through theoretical analysis.

(7) Alternatively, in the power supply apparatus, the at least one resonance capacitor may include: a first series resonance capacitor connected in series with the first coil; a second series resonance capacitor connected in series with the second coil; and a parallel resonance capacitor connected in parallel with the first coil and the first series resonance capacitor and in parallel with the second coil and the second series resonance capacitor. In this case, it is possible to impart both series characteristics and parallel characteristics to each of the resonance between the first coil and the power transmission coil and the resonance between the second coil and the power reception coil. Consequently, it will become possible to achieve a balance between the suppression of currents flowing respectively through those of the plurality of relay coils which do not directly face the power transmission coil and the setting of resonance conditions. In addition, although the at least one resonance capacitor may include a single first series resonance capacitor and a single second series resonance capacitor, from the viewpoint of noise countermeasures, the at least one resonance capacitor may alternatively include two first series resonance capacitors provided respectively at two ends of the first coil and/or two second series resonance capacitors provided respectively at two ends of the second coil.

(8) Further, in the above configuration example (7), the capacitances of the first series resonance capacitor, the second series resonance capacitor and the parallel resonance capacitor may be determined by the solutions of simultaneous equations consisting of: a first voltage equation taking into account a power transmission voltage applied to a circuit including the power transmission coil and a first capacitor for resonance, the inductance of the power transmission coil, the capacitance of the first capacitor, the mutual inductance between the power transmission coil and the first coil, and the circuit impedance; a second voltage equation taking into account the inductance of the first coil in a circuit including the first coil, the first series resonance capacitor and the parallel resonance capacitor, the capacitance of the first series resonance capacitor, the capacitance of the parallel resonance capacitor, the mutual inductance between the power transmission coil and the first coil, and the circuit impedance; a third voltage equation taking into account the inductance of the second coil in a circuit including the second coil, the second series resonance capacitor and the parallel resonance capacitor, the capacitance of the second series resonance capacitor, the capacitance of the parallel resonance capacitor, the mutual inductance between the second coil and the power reception coil, and the circuit impedance; and a fourth voltage equation taking into account the inductance of the power reception coil in a circuit including the power reception coil and a second capacitor for resonance, the capacitance of the second capacitor, the mutual inductance between the second coil and the power reception coil, and the circuit impedance. In this way, the capacitances of the first series resonance capacitor, the second series resonance capacitor and the parallel resonance capacitor can be set to proper values through theoretical analysis.

(9) In any of the above configuration examples (1) to (8), the moving object may include a tired wheel; and the plurality of relay coils may be arranged along a circumferential direction of the tired wheel, and be configured to successively relay the supply of electric power from the power transmission coil to the power reception coil according to the rotational position of the tired wheel during movement of the moving object. In this way, electric power can be efficiently and continuously supplied from the power transmission coil to the power reception coil via the plurality of relay coils provided in the tired wheel. It should be noted that: the moving object may include a plurality of tired wheels; and all or some of the plurality of tired wheels may each have a plurality of relay coils provided therein. Moreover, in the case of providing a plurality of relay coils in a tired wheel, the plurality relay coils may be arranged along the circumferential direction of the tire wheel so as to be spaced apart from one another by a predetermined distance or a predetermined central angle. Alternatively, the plurality relay coils may be arranged along the circumferential direction of the tire wheel so as to overlap or adjoin one another in the circumferential direction. Furthermore, for each of the plurality relay coils, the first and second coils of the relay coil may be arranged so that when viewed from the rotation axis of the tired wheel, the first and second coils overlap each other and the direction of current flowing through the first coil and the direction of current flowing through the second coil are opposite to each other. In addition, the tired wheel may include a tire in which a metal belt is used; and the first coil may be configured as a coil pattern formed on the metal belt.

(10) In the above configuration example (9), each of the plurality of relay coils may have the first coil thereof provided within a tire of the tired wheel, and have the second coil thereof provided within a wheel of the tired wheel. In this case, it is possible to reduce the interval between the first coil and the power transmission coil, thereby facilitating improvement of the electric power supply efficiency. Moreover, it is also possible to locate the second coil close to the axle of the moving object, thereby allowing the second coil to be magnetic-field-coupled to the power reception coil at a position away from the surface on which the moving object moves. In other words, it is possible to locate the second coil further to the moving object side, thereby facilitating arrangement of the power reception coil. Electric conductors, which connect the first coil and the second coil, may be arranged to extend through a through-hole formed in the wheel. Moreover, a hermetic seal may be provided in an electrically insulated manner between the through-hole and the electric conductors. In addition, the heretic seal may be easily realized by filling the gap(s) between the through-hole and the electric conductors with an electrically-insulative adhesive or sealant. Alternatively, the second coil may be provided outside the tired wheel and thus be magnetic-field-coupled to the power reception coil at a position outside the tired wheel. In this case, the electrical conductors, which connect the first coil and the second coil, may be arranged to penetrate the tire. Moreover, in this case, a hermetic seal may also be provided to maintain airtightness of the tire in the same manner as in the case of providing the second coil within the wheel. In addition, the electrical conductors may be implemented by Litz wires or busbars.

(11) In the above configuration example (10), the at least one resonance capacitor may include a resonance capacitor involved in setting of the resonance frequency of the second coil and provided within the wheel of the tired wheel. In this case, since heat generation in the connection circuit can be suppressed, increase in the temperature in the space within the wheel, where it is difficult for heat to be dissipated, can also be suppressed. In addition, heat-generating parts including the second coil may be mounted to a thermally-conductive plate formed of a material having high thermal conductivity (e.g., copper or aluminum) or be connected to a heat pipe or the like, thereby allowing heat to be transferred to the wheel and then dissipated therefrom.

(12) In the above configuration example (10), the at least one resonance capacitor may include a resonance capacitor involved in setting of the resonance frequency of the first coil and provided within the tire of the tired wheel. In this case, since heat generation in the connection circuit can be suppressed, increase in the temperature in the space within the tire, where it is difficult for heat to be dissipated, can also be suppressed.

(13) In the above configuration example (9), the plurality of relay coils may be arranged, with respect to the rotation axis of the tired wheel, respectively at a plurality of positions that divide a circumference of the tired wheel at equal angles. In this case, if the moving object moves at a constant speed, the intervals between peaks of the electromotive force generated in the power reception coil will be constant and thus the frequency of the supplied electric power will be stable, allowing the power reception circuit to operate efficiently. It should be noted that the plurality of relay coils may alternatively be arranged at irregular central-angle intervals.

(14) In any of the above configuration examples (1) to (8), at least one of the power transmission coil and the power reception coil may include a magnetic body that changes the mutual inductances thereof with the plurality of relay coils; and in each of the plurality of relay coils, the at least one resonance capacitor may have a capacitance set using a maximum value of the inductance of the relay coil. In this way, even if at least one of the power transmission coil and the power reception coil includes a magnetic body that changes the mutual inductances thereof with the plurality of relay coils, it is still possible to enable the power supply apparatus to operate properly.

(15) According to a second aspect of the present disclosure, a power supply system is provided. The power supply system includes: the power supply apparatus according to the first aspect of the present disclosure; a plurality of power transmission coils arranged along the surface on which the moving object moves; and a power transmission apparatus configured to cause alternating current, which has a frequency corresponding to the resonance frequency, to flow through at least one of the plurality of power transmission coils on which the moving object is located. With the above configuration, it becomes possible to improve the electric power supply efficiency of the overall power supply system, thereby making it possible to drive the moving object with less electric power. For example, in the case of the moving object being a vehicle that travels on electricity (e.g., an electric vehicle), it is possible to reduce the supplied electric power required for the vehicle to travel a given distance.

(16) According to a third aspect of the present disclosure, a design method is provided. The design method is a method of designing a power supply system that includes a power supply apparatus. The design method is characterized by determining, according to the electric power supply efficiency of the overall power supply system that depends on the currents flowing respectively through the plurality of relay coils of the power supply apparatus, which one of the connection circuit configurations according to the above configuration examples (2), (3), (5) and (7) should be employed in the power supply apparatus. With the design method, it becomes possible to design a power supply system by selecting a configuration of the connection circuit suitable for the power supply system.

The present disclosure is not limited to the above-described embodiments, and can be implemented in various configurations without departing from the gist of the present disclosure. For example, technical features of the embodiments corresponding to technical features in each aspect described in the summary section may be replaced or combined as appropriate in order to solve some or all of the above-described problems or achieve some or all of the above-described advantageous effects. Moreover, the technical features may be deleted as appropriate unless they are described as essential in the present description.

The control units and the control methods described in the present disclosure may be realized by a dedicated computer that includes a processor, which is programmed to perform one or more functions embodied by a computer program, and a memory. As an alternative, the control units and the control methods described in the present disclosure may be realized by a dedicated computer that includes a processor configured with one or more dedicated hardware logic circuits. As another alternative, the control units and the control methods described in the present disclosure may be realized by one or more dedicated computers configured with a combination of a processor programmed to perform one or more functions, a memory and a processor configured with one or more dedicated hardware logic circuits. In addition, the computer program may be stored as computer-executable instructions in a computer-readable non-transitory tangible recording medium. It should be noted that “computer-readable non-transitory tangible recording media” are not limited to portable recording media such as floppy disks and CD-ROMs, but also include internal storage devices provided in computers, such as various RAMs and ROMs, and external storage devices connected to computers, such as hard disks. That is, the term “computer-readable non-transitory tangible recording media” has a broad meaning including any recording media capable of storing data packets non-transiently.

What is claimed is:

1. A power supply apparatus comprising:
a power reception coil mounted to a moving object;
a plurality of relay coils configured to successively relay supply of electric power from a power transmission coil to the power reception coil during movement of the moving object, the power transmission coil being arranged along a surface on which the moving object moves; and
a power reception circuit connected with the power reception coil to receive the electric power for use in the moving object,
wherein each of the plurality of relay coils includes a first coil configured to be magnetic-field-coupled to the power transmission coil according to movement position of the moving object, a second coil configured to be magnetic-field-coupled to the power reception coil when the first coil is magnetic-field-coupled to the power transmission coil, and a connection circuit that connects the first coil and the second coil,
the connection circuit includes at least one resonance capacitor involved in setting of a resonance frequency of at least one of the first coil and the second coil, and
the at least one resonance capacitor has a parallel characteristic.

2. The power supply apparatus as set forth in claim 1, wherein
the at least one resonance capacitor comprises:
a parallel resonance capacitor connected in parallel with the first coil; and
a series resonance capacitor connected in series with the second coil.

3. The power supply apparatus as set forth in claim 2, wherein
capacitances of the parallel resonance capacitor and the series resonance capacitor are determined by solutions of simultaneous equations consisting of:
a first voltage equation taking into account a power transmission voltage applied to a circuit including the power transmission coil and a first capacitor for resonance, inductance of the power transmission coil, capacitance of the first capacitor, mutual inductance between the power transmission coil and the first coil, and the circuit impedance;
a second voltage equation taking into account inductance of the first coil in a circuit including the first coil and the parallel resonance capacitor, capacitance of the parallel resonance capacitor, the mutual inductance between the power transmission coil and the first coil, and the circuit impedance;
a third voltage equation taking into account inductance of the second coil in a circuit including the second coil, the parallel resonance capacitor and the series resonance capacitor, the capacitance of the parallel resonance capacitor, capacitance of the series resonance capacitor, mutual inductance between the second coil and the power reception coil, and the circuit impedance; and
a fourth voltage equation taking into account inductance of the power reception coil in a circuit including the power reception coil and a second capacitor for resonance, capacitance of the second capacitor, the mutual inductance between the second coil and the power reception coil, and the circuit impedance.

4. The power supply apparatus as set forth in claim 1, wherein
the at least one resonance capacitor comprises a parallel resonance capacitor connected in parallel with each of the first coil and the second coil.

5. The power supply apparatus as set forth in claim 1, wherein
the at least one resonance capacitor comprises:
a series resonance capacitor connected in series with the first coil; and
a parallel resonance capacitor connected in parallel with the second coil.

6. The power supply apparatus as set forth in claim 5, wherein
capacitances of the series resonance capacitor and the parallel resonance capacitor are determined by solutions of simultaneous equations consisting of:
a first voltage equation taking into account a power transmission voltage applied to a circuit including the power transmission coil and a first capacitor for resonance, inductance of the power transmission coil, capacitance of the first capacitor, mutual inductance between the power transmission coil and the first coil, and the circuit impedance;
a second voltage equation taking into account inductance of the first coil in a circuit including the first coil, the series resonance capacitor and the parallel resonance capacitor, capacitance of the series resonance capacitor, capacitance of the parallel resonance capacitor, the mutual inductance between the power transmission coil and the first coil, and the circuit impedance;
a third voltage equation taking into account inductance of the second coil in a circuit including the second coil and the parallel resonance capacitor, the capacitance of the parallel resonance capacitor, mutual inductance between the second coil and the power reception coil, and the circuit impedance; and
a fourth voltage equation taking into account inductance of the power reception coil in a circuit including the power reception coil and a second capacitor for resonance, capacitance of the second capacitor, the mutual inductance between the second coil and the power reception coil, and the circuit impedance.

7. The power supply apparatus as set forth in claim 1, wherein
the at least one resonance capacitor comprises:
a first series resonance capacitor connected in series with the first coil;
a second series resonance capacitor connected in series with the second coil; and
a parallel resonance capacitor connected in parallel with the first coil and the first series resonance capacitor and in parallel with the second coil and the second series resonance capacitor.

8. The power supply apparatus as set forth in claim 7, wherein
capacitances of the first series resonance capacitor, the second series resonance capacitor and the parallel resonance capacitor are determined by solutions of simultaneous equations consisting of:
a first voltage equation taking into account a power transmission voltage applied to a circuit including the power transmission coil and a first capacitor for resonance, inductance of the power transmission coil, capacitance of the first capacitor, mutual inductance between the power transmission coil and the first coil, and the circuit impedance;
a second voltage equation taking into account inductance of the first coil in a circuit including the first coil, the first series resonance capacitor and the parallel resonance capacitor, capacitance of the first series resonance capacitor, capacitance of the parallel resonance capacitor, the mutual inductance between the power transmission coil and the first coil, and the circuit impedance;
a third voltage equation taking into account inductance of the second coil in a circuit including the second coil, the second series resonance capacitor and the parallel resonance capacitor, capacitance of the second series resonance capacitor, the capacitance of the parallel resonance capacitor, mutual inductance between the second coil and the power reception coil, and the circuit impedance; and
a fourth voltage equation taking into account inductance of the power reception coil in a circuit including the power reception coil and a second capacitor for resonance, capacitance of the second capacitor, the mutual inductance between the second coil and the power reception coil, and the circuit impedance.

9. The power supply apparatus as set forth in claim 1, wherein
the moving object includes a tired wheel, and
the plurality of relay coils are arranged along a circumferential direction of the tired wheel, and configured to successively relay the supply of electric power from the power transmission coil to the power reception coil according to rotational position of the tired wheel during movement of the moving object.

10. The power supply apparatus as set forth in claim 9, wherein
each of the plurality of relay coils has the first coil thereof provided within a tire of the tired wheel, and has the second coil thereof provided within a wheel of the tired wheel.

11. The power supply apparatus as set forth in claim 10, wherein
the at least one resonance capacitor comprises a resonance capacitor involved in setting of the resonance frequency of the second coil and provided within the wheel of the tired wheel.

12. The power supply apparatus as set forth in claim 10, wherein
the at least one resonance capacitor comprises a resonance capacitor involved in setting of the resonance frequency of the first coil and provided within the tire of the tired wheel.

13. The power supply apparatus as set forth in claim 9, wherein
the plurality of relay coils are arranged, with respect to a rotation axis of the tired wheel, respectively at a plurality of positions that divide a circumference of the tired wheel at equal angles.

14. The power supply apparatus as set forth in claim 1, wherein
at least one of the power transmission coil and the power reception coil includes a magnetic body that changes inductances of the plurality of relay coils, and
in each of the plurality of relay coils, the at least one resonance capacitor has a capacitance set using a maximum value of the inductance of the relay coil.

15. A power supply system comprising:
the power supply apparatus as set forth in claim 1;
a plurality of power transmission coils arranged along the surface on which the moving object moves; and
a power transmission apparatus configured to cause alternating current, which has a frequency corresponding to the resonance frequency, to flow through at least one of the plurality of power transmission coils on which the moving object is located.
